(19) United States
(12) Patent Application Publication
(10) Pub. No.: US 2014/0324747 A1
(43) Pub. Date: Oct. 30, 2014

(54) ARTIFICIAL CONTINUOUSLY RECOMBINANT NEURAL FIBER NETWORK

(71) Applicant: Raytheon Company, (US)

(72) Inventors: James A. Crowder, Englewood, CO (US); John N. Carbone, Garland, TX (US)

(73) Assignee: Raytheon Company, Waltham, MA (US)

(21) Appl. No.: 13/873,751

(22) Filed: Apr. 30, 2013

(51) Int. Cl. G06N 3/08

(52) U.S. Cl. CPC G06N 3/086
USPC 706/18; 706/20

(57) ABSTRACT

Embodiments of a system and method for an artificial cognitive neural framework are generally described herein. In some embodiments, the artificial cognitive neural framework includes a memory system for storing acquired knowledge and for broadcasting the acquired knowledge, cognitive system, including cognitive perceptrons arranged to develop hypotheses and produce information, and genetic learning algorithms and a mediator, coupled to the cognitive system, the mediator arranged to gather the developed hypotheses and the produced information, to integrate the developed hypotheses and produced information using fuzzy, self-organizing contextual topic maps and to establish proper mappings between inputs, internal states and outputs of a continuously recombinant neural fiber network, wherein the genetic learning algorithms are arranged to continuously evolve candidate solutions by adjusting interconnections in the continuously recombinant neural fiber network by correlating patterns within the candidate solutions to stochasto-chaotic constraints, and to update the memory system.

### BACKGROUND

The introduction of artificial intelligence (AI) into system designs poses issues and challenges for system designers. Information processing and dissemination systems are an expensive infrastructure to operate and more-often-than-not these systems fail to provide analysts with tangible and useful situational information, typically overwhelming information analysts with system messages and other low-level data. Real-time human decision making processes may be supported by information derived from fusion of data into information and knowledge, so information analysts may make informed decisions. This translation of data-into-information-into-knowledge changes the way data/information is represented, fused, refined and disseminated.

The prefrontal cortex has long been suspected to play a role in cognitive control and the ability to orchestrate thought and action in accordance with internal goals. Cognitive control stems from the active maintenance of patterns of activity in the prefrontal cortex that represent goals and the means to achieve them.

The functions carried out by the prefrontal cortex area may be described as executive functions. Executive functions relate to top-down processing that provide the ability to differentiate among conflicting thoughts, behavior, degree, consequences of current activities, etc. The ability to be guided by internal states or intentions is driving toward the cognitive concept of mindfulness, which is awareness without distortion or judgment.

Following the evolution of diagnostic systems, prognostic initiatives take advantage of maintenance planning and logistics benefits. In the real-time battlefield arena, situational awareness is involved with making the right decisions and achieving the overall goals for the system. Situational awareness is not simply collecting and disseminating data, but it is actually getting the right information to the right users at the right time. Artificial intelligent systems today lack the ability to turn the data into meaningful information, and to reason about that information in a context relative to the user at that time, and to update the information real-time as the situation changes. Further, there are many situations where a neural network may be capable of learning and adapting to its changing environment, such as integrated system health management, automated target recognition, data retrieval, data correlation and processing, etc.

Neural systems tend to forget previously learned neural mappings quickly when exposed to new types of data environments, a phenomenon known as catastrophic interference (CI). There have been attempts to alleviate CI by reducing the coupling, or unlearning, in such networks or by using networks with localized processing responses, i.e., adding neural structure is done at the local level, not global. Unfortunately, these types of systems may lead to unbounded growth due to a lack of an efficient priming mechanism.

Humans synthesize models that enable reasoning about what is perceived to understand the world. Intelligence information available for analysis is collected from diverse sources, rendering it fuzzy. These diverse sources often do not have consistent contextual bases and this introduces ambiguity into the correlation and inference processes applied to the combined information. Finding related events and inferring likely outcomes from such data is a challenging task.

Fortunately, humans are able to deal with fuzziness. Humans have the ability to perceive the visual world and form concepts to describe and make decisions. To do this, language is used fuzzily and communication fuzzily adapts and evolves to best fit the needs of personal and conceptual views, along with goals and vision. Add to fuzziness, obfuscation and the task of creating an artificial intelligent system (AIS) that is autonomous, e.g., may think, reason, learn, and act based on what it takes in and what it already knows, also poses a significant challenge.

### BRIEF DESCRIPTION OF THE DRAWINGS

FIG. 1 illustrates an artificial intelligent system according to an embodiment;

FIG. 2 illustrates a continuously recombinant neural fiber network according to an embodiment;

FIG. 3 illustrates artificial cognitive neural framework (ACNF) according to an embodiment;

FIG. 4 illustrates a cognitive perceptron ISA ontology according to an embodiment;

FIG. 5 illustrates an artificial prefrontal cortex (APC) affected state model according to an embodiment;

FIG. 6 illustrates the ANCF memory architecture according to an embodiment;

FIG. 7 illustrates information fragment encoding within the ACNF according to an embodiment;

FIG. 8 illustrates learning management within the ACNF according to an embodiment;

FIG. 9 illustrates an Occam learning environment according to an embodiment;

FIG. 10 illustrates the artificial prefrontal cortex (APC) inference flow according to an embodiment;

FIG. 11 illustrates capabilities of the artificial prefrontal cortex according to an embodiment;

FIG. 12 illustrates a fuzzy, self-organizing, contextual topical map (FSOCTM) according to an embodiment;

FIG. 13 illustrates the superimposition of a fuzzy, self-organizing, contextual topical map onto a fuzzy, self-organizing map according to an embodiment;

FIG. 14 illustrates a structure for a dialectic search argument (DSA) according to an embodiment;

FIG. 15 illustrates an evolving, life-like yielding, symbiotic environment (ELYSE) architecture according to an embodiment;

FIG. 16 illustrates an evolving, life-like yielding, symbiotic environment (ELYSE) processing framework according to an embodiment;

FIG. 17 illustrates a conscious, cognitive agents connectivity architecture according to an embodiment;

FIG. 18 illustrates ACNF cognitive perceptron artificial cognition infrastructure that drives the coalitions and provides the infrastructure for the hybrid neural processing environment according to an embodiment;

FIG. 19 illustrates a design-in approach to integrated system health management (ISHM) according to an embodiment;

FIG. 20 illustrates functional layers in an integrated system health management (ISHM) system according to an embodiment;

FIG. 21 illustrates intelligent information agents (I²A) for a prognostic process according to an embodiment;

FIG. 22 illustrates prognostic analyst agent processing according to an embodiment;

FIG. 23 shows the inputs and outputs to a prognostics analyst agent according to an embodiment;

FIG. 24 illustrates the ISHM decision making process according to an embodiment;

FIG. 25 illustrates intelligent information agents (I²A) network system according to an embodiment;

FIG. 26 illustrates a functions data steward and advisor agent according to an embodiment;

FIG. 27 illustrates functions of a reasoner agent according to an embodiment;

FIG. 28 illustrates functions of an analyst agent according to an embodiment;

FIG. 29 illustrates a federated search process within the integrated system health management system according to an embodiment;

FIG. 30 illustrates a question and answer architecture for the integrated system health management system according to an embodiment;

FIG. 31 illustrates a possible intelligent dialectic search argument (DSA) software agency according to an embodiment; and

FIG. 32 illustrates a block diagram of an example machine for providing artificial continuously recombinant neural fiber network according to an embodiment

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass available equivalents of those claims.

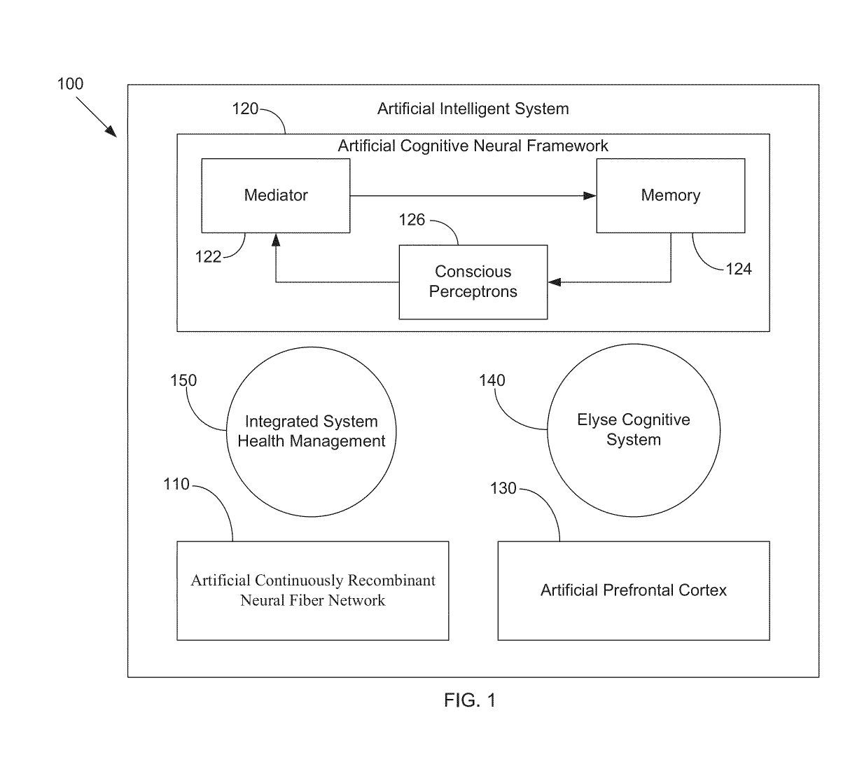

FIG. 1 illustrates an artificial intelligent system 100 according to an embodiment, FIG. 1 shows an artificial continuously recombinant neural fiber network 110 that uses a fuzzy, self-organizing topical map, genetic learning algorithms, and stochasto-chaotic constraints on the neural fiber connections to determine constraint optimization to optimize the artificial continuously recombinant neural fiber network 110.

An artificial cognitive neural framework (ACNF) 120 provides the ability to organize information semantically into meaningful fuzzy concepts and information fragments that create cognitive hypotheses as part of its topology. The ACNF 120 addresses the problems of autonomous information processing by accepting that the system may purposefully communicate concepts fuzzily within its processing system, often inconsistently, in order to adapt to a changing real-world, real-time environment. The ACNF 120 processing framework allows the system to deal with real-time information environments, including heterogeneous types of fuzzy, noisy, and obfuscated data from a variety of sources with the Objective of improving actionable decisions using recombinant knowledge assimilation (RNA) processing integrated within an artificial cognitive neural (ANF) framework to recombine and assimilate knowledge based upon human cognitive processes. The cognitive processes are formulated and embedded in a neural network of genetic algorithms and stochastic decision making with the goal of recombinantly minimizing ambiguity and maximizing, clarity while simultaneously achieving a predetermined result.

The ACNF 120 includes a mediator 122, memory 124 and conscious perceptrons 126. An artificial prefrontal cortex (APC) 130 provides for planning complex cognitive behavior, is involves with personality expression, controls decision making and moderates social behavior. The evolving, life-like yielding, symbiotic environment (ELYSE) system 140 allows the system to dynamically adapt its structure as it evolves and learns more about the types of environments it deals with.

An integrated system health management (ISHM) processing architecture 150 allows users to turn the data into meaningful information, and to reason about that information in a context relative to the user at that time, and to update the information real-time as the situation changes. The ISHM architecture 150 uses an intelligent information agent processing environment that allows data to be processed into relevant, actionable knowledge. The ISHM architecture 150 uses the ACNF 120 to provide real-time processing and display of dynamic, situational awareness information. Each of these components will be discussed in greater detail below.

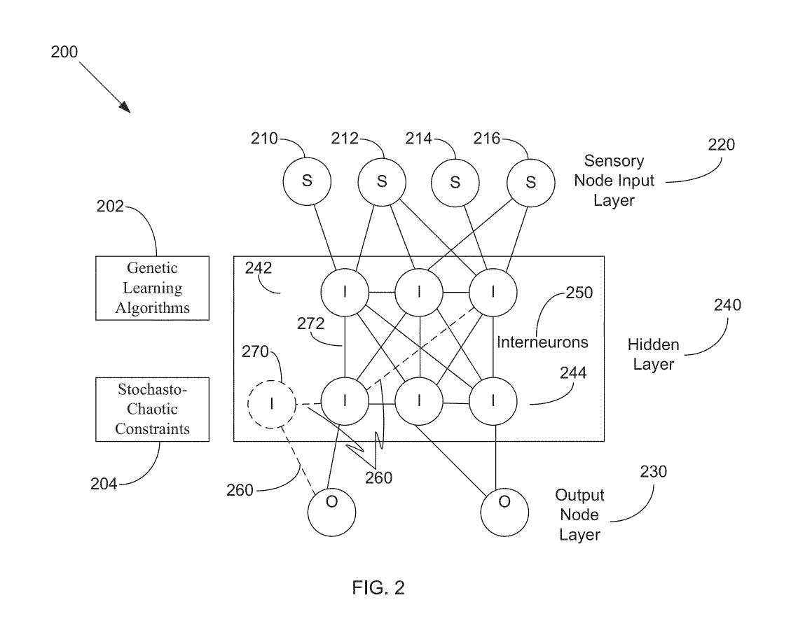

FIG. 2 illustrates a continuously recombinant neural fiber network 200 according to an embodiment. The continuously recombinant neural fiber network 200 utilizes a fuzzy, self-organizing topical map, genetic learning algorithms 202, and stochasto-chaotic constraints 204 on the neural fiber connections to determine constraint optimization. This allows the system to find the best recombinant neural fiber system that will capture the characteristics of a knowledge object. In FIG. 2, a plurality of sensor nodes 210-216 at an input layer 220 for receiving data for processing. Neural networks also have an output layer 230. A hidden layer 240 includes interneurons 250 that utilize stochasto-chaotic constraints 250 to allow continuous adjustments in inter-neural perceptions, i.e., how they relate to each other, and adjust their perceptional processing accordingly. The hidden layer 240 learns to recode or to provide a representation for the data received at the sensor nodes at the input layer 220. In FIG. 2, the hidden layer 240 includes a first hidden layer 242 and a second hidden layer 244. FIG. 2 also shows that the interneurons 250 are interconnected and thus learn from each other. FIG. 2 shows new connections 260 and a new interneuron 270 being added to the hidden layer 240.

The recombinant neural fibers represent the continuously recombinant nature and learning nature of the network. Layer n+1 242, during its generational evolution, develops neural fiber connections 272 between layer nodes to aid in the learning process of the evolution of the neural fiber. The continuously recombinant neural fiber network 200 solves orthogonometric stochastic/chaotic Stratonovich differential equation pairs across a multidimensional parametric space.

These intra-neural connections 270 allow the network 200 to more efficiently evolve when intralayer nodes, e.g., between the input layer 220 and the hidden layer 240, communicate and learn from each other. During genetic synthesis and recombinant neural fiber generations, connections, uni- and bi-directional connections, are created and assessed. During successive generations of genetic neural structures may skip a neural generation, depending on the stochasto-chaotic constraints imposed on generational fiber evolution. The internal neural structure conformed to:

$$τ {\dot{y}}_{i} = {y}_{i } + {\sum }_{j = 1}^{N} {w}_{ji} σ ( {g}_{j} ( {y}_{j} + {θ}_{j} ) ) + {I}_{i} , i = 1 , … , N$$

where:

y is the state of each neuron,

t is its time constant,

wⱼᵢ is the connection from the jth to the ith neuron,

g is a gain,

θ is a stochasto-chaotic term,

$$σ ( x ) = \frac{1}{( 1 + {e}^{- x} )}$$

is the standard logistic activation function, and

I represents an external sensor input (depending on the neuron)

States are initialized utilizing a forward Stratonovich function, e.g., may use a nominal integration step size of 0.1.

Chaotic calculus is used to derive the stochasto-chaotic constraints for the fuzzy, continuously recombinant neural fiber network. In particular, chaos expansions for Markov chains are produced via orthogonal functionals that are analogous to multiple stochastic integrals. By looking at environments that converge, orthogonally, to stochastic differentials and chaotic differentials, the environment may be captured and the existence and connectivity of pulses that form intelligent sequences, in a stochastic and chaotic sense, are determined. Solutions in chaotic calculus, e.g., via Martingales, are expressed as multiple stochastic and chaotic integrals using polynomial solutions, e.g., utilizing Meixner and Krawtchouk polynomials. These solutions may be constructed utilizing Renyi's mutual information theory. In this way, the stochastic and chaotic functionals may be computed as discrete iterated integrals with respect to a compensated binomial process.

The Krawtchouk polynomial differential solutions are derived by generating the Koekoek and Swarttouw function which is a stochastic process and allows construction of orthogonal functionals of Markov chains. This construction is related to the chaos expansion:

$$\tilde{f} ( {k}_{1} , … , {k}_{n} ) = \frac{1}{n !} {\sum }_{σ ∈ {\sum }_{n}}^{ } {f}_{n} ( {k}_{σ ( 1 )} , … , {k}_{σ ( n )} ) , {k}_{1} , … , {k}_{n} \geq 1$$

assuming finite Markov chains in continuous time. The notion of orthogonal tensor Markov chains where one is stochastic and one is chaotic provides the two main conditions of a multiply agile signal put through a non-linear, stochastic function. The pseudo-randomness of the functions provides a standard Markov solution, while the stochastic input through the non-linear functions provide a chaotic Markov solution that is orthogonal to the stochastic Markov solution. For random processes, the solutions will be orthogonal. For pseudorandom processes, the solutions will simultaneously solve a stochastic and chaotic equation and may converge in the solution space. The non-pseudorandom “noise” in the environment may solve distinctly orthogonal stochastic/chaotic pairs of equations and show up in the solution space as orthonometric pairs of solutions. The isometric stochastic/chaotic chain looks like:

$${J}^{n} ( {1}_{[ 1 , N ]}^{° n} ) = {\sum }_{d = 1}^{d = n} {\sum }_{{1 \leq {i}_{d}}_{{n}_{1 + … + {n}_{d} = n}}} \frac{n !}{{n}_{1} ! , … {n}_{d} !} {\prod }_{k = 1}^{k = d} {ϕ}^{{n}_{k}} ( {S}_{{i}_{k}} ( {S}_{{i}_{k}} \vert {S}_{{i}_{k} - 1} )$$

and from here the Stochastic Markov is constructed as:

$${ɛ}_{N}^{°} ( z ) = {\sum }_{n = 0}^{n = N} {z}^{n} {J}_{n} ( {1}_{[ 1 , N ]}^{° n} = {\sum }_{n = 0}^{n = N} {z}^{n} {\sum }_{d = 0}^{d = N} {\sum }_{{1 \leq {i}_{1} < … {i}_{d}}_{{n}_{1} + … + {n}_{d} = n}}^{ } \frac{n !}{{n}_{1} ! , … {n}_{d} !} {\prod }_{k = 1}^{k = d} {ϕ}^{{n}_{k}} ( {S}_{{i}_{k}} ( {S}_{{i}_{k}} \vert {S}_{{i}_{k} - 1} ) , \\ z ∈ R$$

and the chaotic Markov is constructed as

Jₙ(fₙ)=Σ_{1≦i}_{₁}_{> . . . i}_{_{d}}fₙ(i₁, . . . , iₙ)Φ₁(Xᵢ_{ₙ})

with

fₙ=Σ_{1≦i}_{₁}_{< . . . i}_{_{d}}fₙ(i₁, . . . , iₙ)eᵢ_{₁}^{o} . . . ^{o}eᵢ_{ₙ},

Solutions to the orthogonometric equations become the constraints for the genetic-neural fuzzy populations of neural fiber threads, eventually forming a neural fiber network that provides a solution.

The performance of the continuously recombinant neural fiber network 200 is highly dependent on its structure. The interaction allowed between the various fiber nodes of the network is specified using the structure only. There may be many neural fiber network structures for a given problem, and there may exist in different ways to define a structure corresponding to the problem. Hence, deciding on the size of the neural fiber network, e.g., the number of nodes, number of interconnections, number of fuzzy, self-organizing topical maps, etc., is also a challenging issue. Too small a neural fiber network will prohibit it from adequately characterizing the signals; too big a one will be too complex to be of practical use.

Determining an optimal neural fiber network topology is a complex problem. It is even impossible to prove that a given structure is optimal, given that there may be many neural fiber structures that may be appropriate. Different combinations of nodes and connections are tried out so that it gives maximum level of response within the given stochasto-chaotic constraints 250. Such methods rely on overall performance of the neural fiber network, so parts of the network that contributed well are difficult to identify. The use of evolutionary programming (EP) provides the mechanism for defining the neural fiber network topology, with their natural makeup of exchanging information. The search space here is also too big, similar architectures may have quite difference performance; different architectures may result in similar performance. This makes EP a better choice as opposed to algorithms that start with a maximal (minimal) network and then delete (add) layers, nodes or connections.

The genotype representation of the neural fiber network architecture directs the working of the continuously recombinant neural fiber network 200. Considerations may be taken so that the optimal neural fiber structures are representable and meaningless structures may be excluded. The EP genetic operators yield valid offspring, and the representation do not grow in proportion to the network. The representation may be able to span potentially useful structures and omit unviable network genotypes. The encoding scheme also constrains the decoding process. A neural fiber network implemented as a continuously recombinant neural fiber network 200 may have a representation expressive enough to describe recurrent networks. Also the decoding mechanism may be able to read this representation and transform it into an appropriate recurrent network.

The low-level or direct encoding techniques specify the neural fiber connections. Indirect encodings are more like grammatical rules; these rules suggest a context free graph grammar according to which the neural fiber network topology may be generated. Direct encoded genotypes increase too fast in length with a growing network. Thus, the maximum topological space has to be limited. This may exclude the fittest structure in the lot, or may result in networks with certain connectivity patterns.

One of the major challenges with evolving the neural fiber network is discovering a meaningful way to crossover disparate fiber topologies. Usual genetic operators will fail to preserve the structural innovations occurring as part of the evolutionary process. Some kind of a speciation may be used so that individuals compete primarily within their own niches, and not with the population at large. This is why EP may be utilized to guarantee that the new parental population is not too far deviated from previous generations. The EP algorithms use methods for historical markings, speciation, and incremental growth from minimal structure for efficient evolution of the neural fiber network topology.

The EP algorithms divide the population into different species on the basis of a compatibility distance measure, utilizing the fuzzy, self-organizing topical maps. This measure is generally derived from the number of disjoint and excess genes between two individuals. If an individual's distance measure from a randomly selected one is less than a fuzzy membership value, then both individuals are placed into the same species.

Once the classification is done, the original membership values are adjusted by dividing by the number of individuals in the species. A species grows if this average adjusted fitness is more than the population average, otherwise it shrinks in size. By doing so, the EP algorithms do not allow any particular structure to dominate over the whole population, but at the same time allows for the growth of the better performing ones, thereby providing both local and global optimization of the neural fiber network (L2 vs. L∞). The same input-output mapping may be implemented by different neural fiber network architectures.

For a given data environment, the topology for a continuously recombinant neural fiber network 200 may be different en though the functional mapping they define may be same. EP algorithms are not able to detect these symmetries and hence a crossover in such a case may result in an unviable offspring. Moreover, in neural fiber networks where more than one signal needs to be learnt, there are chances of incompatible roles gating combined leading problems with neural fiber network convergence. A simple solution to these problems may be to restrict the selection operator to small populations, and to introduce intuitive biased measures in crossover and mutation.

The continuously recombinant neural fiber network 200 is capable of learning very high-order possibilistic correlations that are present in a data environment. The learning algorithms 202 provide a powerful mechanism for generalizing behavior to new environments. For these neural fiber networks, endogenous goals play a role in determining behavior and EP methodologies are the appropriate mechanism for developing goals and purposeful behavior.

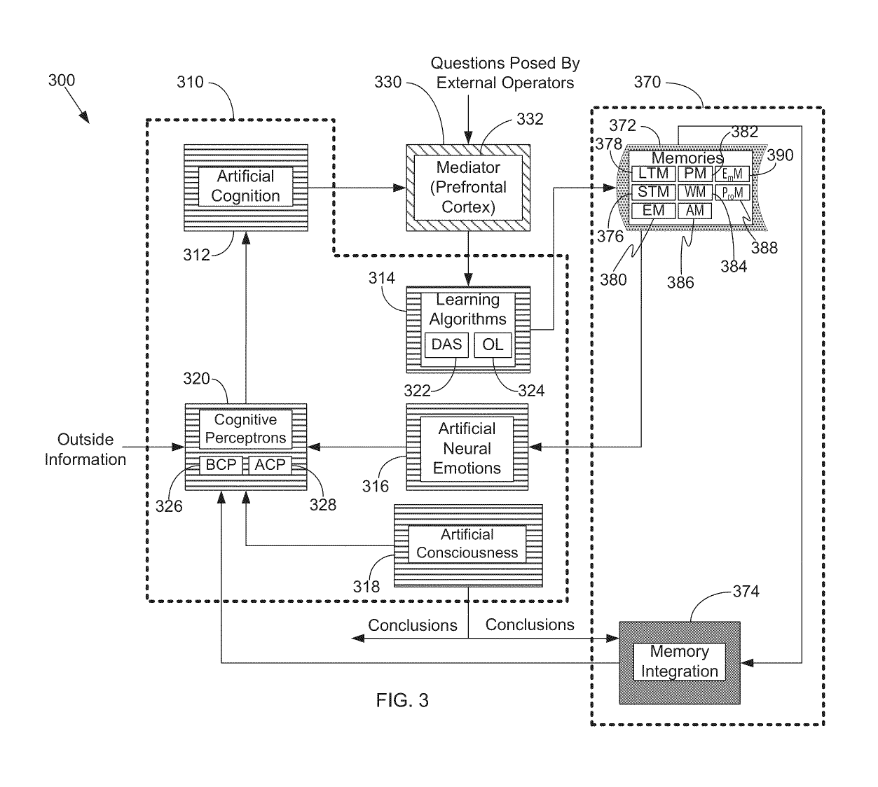

FIG. 3 illustrates artificial cognitive neural framework (ACNF) 300 according to an embodiment. The ACNF 300 organizes information semantically into meaningful fuzzy concepts and information fragments that create cognitive hypotheses as part of its topology. This approach addresses the problems of autonomous information processing by accepting that the ACNF 300 may purposefully communicate concepts fuzzily within its processing system, often inconsistently, in order to adapt to a changing real-world, real-time environment. Additionally, a processing framework allows the ACNF 300 to deal with real-time information environments, including heterogeneous types of fuzzy, noisy, and obfuscated data from a variety of sources with the objective of improving actionable decisions using recombinant knowledge assimilation (RNA) processing integrated within the framework of the ACNF 300 to recombine and assimilate knowledge based upon human cognitive processes. The cognitive processes are formulated and embedded in a neural network of genetic algorithms and stochastic decision making with the goal of recombinantly minimizing ambiguity and maximizing clarity while simultaneously achieving a predetermined result.

The ACNF 300 is a cognitive processing architecture that provides a hybrid computing architecture using genetic, neural-network, fuzzy, and complex system components that allow integration of diverse information sources, associated events, and multiple learning and memory systems to make observations, process information, make inferences, and decisions. Within the ACNF 300, continuously recombinant neural fiber networks are utilized to map complex memory and learning patterns as the system learns and adapts. The ACNF 300 system “lives” and communicates via intelligent information software agents (ISA), which are also referred to as cognitive perceptrons, that mimic human reasoning by understanding how to create and develop hypotheses.

The processing framework, or ACNF 300, provides a collection of constraints, building blocks, design elements, and rules for composing the cognitive aspects. The three main subsystems within the ACNF 300 are the cognitive system 310, the mediator 330 and the memory system 370.

The cognitive system 310 includes the artificial cognition 312, learning algorithms 314, artificial neural emotions 316, artificial consciousness 318, and cognitive perceptrons 320, which make up the consciousness structures. The cognitive system 310 is responsible for the cognitive functionality of perception, consciousness, emotions, informational processing, and other cognitive functions within the ACNF 300.

The artificial cognition 312 provides reasoning and hypotheses about known and unknown information. The artificial cognition 312 also gathers and provides information and questions posed from internal processes to the mediator. The mediator 330 includes an artificial prefrontal cortex 332, which is described in detail below.

The mediator 330 takes information from the cognitive perceptrons 320, processed through the processes of the artificial cognition 312, and forms coalitions of cognitive perceptrons 320 that are used to update the memories 372. The mediator 330 uses fuzzy, self-organizing contextual topical maps to integrate information, intelligence, and memory, and delivers knowledge and knowledge characteristics across the system.

Within the ACNF 300, the mediator 300, provides cognitive intelligence for the ACNF 300 and allows for rapid analysis, reasoning, and reporting capabilities. The mediator 330 also supports cognitive control, e.g., the ability to orchestrate thought and action in accordance with internal goals and is involved in the planning of complex cognitive behaviors, personality expression, decision making and moderating correct social behavior. The basic activity is considered to be orchestration of thoughts and actions in accordance with internal goals. Cognitive control stems from the active maintenance of patterns of activity in the mediator that represent goals and the means to achieve them. They provide bias signals to other cognitive structures whose net effect is to guide the flow of activity along neural pathways that establish the proper mappings between inputs, internal states, and outputs used to perform a given task.

The memory system 370 includes the memories 372 and memory integration function 374. The memories 372 may include short-term memory 376, long-term memory 378, and episodic memories 380. Other memories 372 may include perceptual memory 382, working memory 384, autobiographical memory 386, procedural memory 388 and emotional memory 390. The memory integration function 374 takes information that is available within the memories 372, e.g., what the system has learned and knows, and continually broadcast it. The artificial consciousness 318 also provides conclusions, which are current processed and encoded information fragments, to the memory integration 374. The memory integration 374 attaches, compares and relates processed and encoded short term memories to other existing memories. The memory integration 374 integrates these inputs to provide integrated world data to the cognitive perceptrons 320 to use during analysis of incoming sensory information.

The artificial neural emotions 316 provide basic emotions patterned after autonomic nervous system arousal states based on the broadcast information from memories 372. The artificial neural emotions 316 communicate with the cognitive perceptrons 320 to provide emotional context. The artificial consciousness 318 performs identification and characterization of information of interest. The artificial consciousness 318 provides contextual awareness to the cognitive perceptrons 320.

The cognitive perceptrons 320 provides analysis and thought processes to the artificial cognition 312, which allows the ACNF 300 to mimic human reasoning in processing information and developing knowledge. This intelligence takes the form of answering questions and explaining situations that the ACNF 300 encounters. The cognitive perceptrons 320 are persistent software components that perceive, reason, act, and communicate. Cognitive perceptrons 320 allow the ACNF 300 to act on its own behalf, allow autonomous reasoning, control, and analysis, allow the ACNF 300 to filter information and to communicate and collaborate with other cognitive perceptrons 320, allow autonomous control to find and fix problems within the ACNF 300, allow pattern recognition and classifications, and allow the ACNF 300 to predict situations and recommend actions, providing automated complex procedures.

The processes of the artificial cognition 312 form local associations of cognitive perceptron 320 from information retrieved from the transient episodic memories 380 and the long-term associative memories 378. Emotional memories 390 and emotional cues are utilized in order to add emotional context that aids in creating the local associations of artificial cognition 312. These local associations contain records of the ISAs past emotions and emotional memories 390 that are contained in the associated situations close to or coincident with the sensory input hypotheses.

Cognitive competition may occur through coalitions of cognitive perceptrons 320 that are formed, and which compete for access to the consciousness processes. Attention cognitive perceptrons 328 bring relevant and/or urgent events to the processes of the artificial consciousness 318. These attention cognitive perceptrons 328 search the long-term memories 378, based on input from the meta-memory processes that information may exist in long-term memories 378 about the subject, topic, or hypothesis currently being processed. As information and context are retrieved, it is possible for coalitions of cognitive perceptrons 320 to be formed, some of which may compete for access to the consciousness processes. This competition may include a number of coalitions of attention cognitive perceptrons 328, including coalitions formed during previous consciousness cycles. It is possible the priorities assigned to coalitions are influenced by the emotional responses, trauma states, and/or other emotional memories. A strong affective emotional response will strengthen a coalition's priority and therefore increase the chances of getting access to the processes of the artificial consciousness 318.

Coalitions of cognitive perceptrons 320 broadcasts content within the ACNF 300 once it has gained access to the processes of the artificial consciousness 318. The coalition of cognitive perceptrons 320 may include an attention cognitive perceptron 328, along with its coalition of relation informational cognitive perceptrons 320, which carry information content, along with informational context. The broadcast by the artificial consciousness 318 may include the contents of this consciousness object, as well as the affective (emotional) information. The broadcast by the artificial consciousness 318 updates the perceptual memory 382, including the emotional content, which may lead to new emotional memories 390. The stronger the affective information, the stronger the emotional memories 390 and triggers that are encoded into memory 372. The transient episodic memories 380 are also updated with the contents of the current consciousness object. During long-term memory cycles, the contents of the episodic memory 380 are consolidated and stored as long-term declarative memory 378. Procedural memory 388 may be updated, modified, or reinterpreted, depending on the strength of the affective portion of the consciousness object.

A coalition of cognitive perceptrons 320 may include many types of cognitive perceptrons 320, thereby allowing the artificial consciousness to handle resource management. Behavior cognitive perceptrons 326 respond to the broadcasts by the artificial consciousness 318. Behaviors are controlled by information from the broadcasts by the artificial consciousness 318 that drives the creation of attention cognitive perceptrons 328. One type of attention cognitive perceptron 328 is an expectation perceptron that may be created due to an unexpected hypothesis or result from a previous consciousness broadcast. In this case, a coalition of cognitive perceptrons 320 may be created in order to handle the unexpected situation. This coalition of cognitive perceptrons 320 may include many types of cognitive perceptrons 320 that allow the artificial consciousness 318 to handle resource management by recruiting resources through the creation of coalitions of cognitive perceptrons 320. The emotional, or affective, content of the coalitions of cognitive perceptrons 320 will affect the attraction of relevant resources, including processor utilization, memory availability, and creation of other coalitions, in order to handle the current perceived situation.

Action selection may be based on the reactions, analyses, hypotheses, and other information provided by the processes of the artificial consciousness 318. The behavior processes select a behavior, or action, driven by both conscious and unconscious goals carried within the ACNF 300. This may be the result of a current situation, or a previous situation that has gained higher priority within the attention manager. Again, the action selection may be heavily influenced by the emotional content of the coalitions of cognitive perceptrons 320. The relationships between previous, current, and possible future behaviors affect activation of actions, as does the residual activation levels (priorities) from the various choices of actions.

Action activation is based on the selection of action(s). The behavior cognitive perceptrons set into motion a chain of actionable events that may drive performance of both internal and external tasks in order to meet its current goals. This will also include a set of expectation cognitive perceptrons 320 whose task it is to monitor the actions performed in order to provide success/failure information to the artificial consciousness processes, based on the expected results. The success or failure information may create new hypotheses and coalitions of cognitive perceptrons 320 in order to deal with this new information from the expectation cognitive perceptrons 320.

The ACNF 300 is a hybrid computing architecture that utilizes genetic, neural-network, fuzzy, and complex system components, that allow integration of diverse information sources, associated events, and multiple learning and memory systems to make Observations, process information, make inferences, and decisions.

Within the ACNF 300, the continuously recombinant neural fiber networks are utilized to map complex memory and learning patterns as the system learns and adapts. The ACNF 300 lives and communicates via intelligent information software agents (ISAs) that mimic human reasoning by understanding how to create and develop hypotheses

The ACNF 300 according to an embodiment provides the meta-cognitive and meta-memory (artificial prefrontal cortex 332), self-assessment and self-reasoning, mechanisms that may be used for systems to be truly autonomous. The cognitive abilities for a fully-autonomous system may include the abilities to infer and reason about concepts and situations that the system has not encountered before.

The learning algorithms 314 include dialectic search structures 322, along with the Occam learning 324, which are driven by computational mechanics concepts, provide the ACNF 300 with the ability to formulate new hypotheses about data, information, and situations not previously encountered by the system. The learning algorithms 314 accomplish these tasks using learning and fuzzy inference engines. These self-discovery mechanisms are used when a system is to be truly autonomous. Further, the learning algorithms 314 communicate with the memories 372 to create, modify and update the memories 372.

Predictive analytics architectures provide mechanisms for understanding and managing the complexity of disparate data sources and the variety of decisions for intelligence analysis. The ACNF 300 according to an embodiment provides a strategic advantage in processing disparate intelligence information. This is achieved by augmenting the abilities of intelligence operatives with a recombinant cognitive analysis and reasoning framework which is capable of learning from intelligence operatives as to how to reason about information. Such an advantage will enhance thinking and reasoning skills, situational awareness, and improve course of action decision making.

The functions carried out by the mediator 330 may be described as executive functions. Executive functions relate to abilities to differentiate among conflicting thoughts, determine good and bad behavior, better and best, same and different, future consequences of current activities, working toward a defined goal, prediction of outcomes, expectation based on actions, and social control.

One of the cognitive concepts for providing autonomous system capabilities includes the ability to perform top-down processing, which involves taking an understanding of the mission or task at hand, from this, define goals and prediction of outcomes, and utilize this knowledge to define the system behaviors used to meet the mission or task goals. For the ACNF 300, executive management and strategic knowledge are provided by the mediator 330. The executive management autonomous system processes involve planning, monitoring, evaluating and revising the cognitive processes and products. Strategic knowledge involves knowing what tasks or operations to perform, e.g., factual or declarative knowledge, knowing when and why to perform the tasks or operations, e.g., conditional or contextual knowledge, and knowing how to perform them, e.g., procedural or methodological knowledge. The ACNF 300 uses both executive management and strategic knowledge capabilities to autonomously self-regulate its own thinking and learning.

Meta-cognition, or knowledge of cognition, refers to what the ACNF 300 knows about its own cognition or about cognition in general. In short, it describes the ability of the ACNF 300 to think about how and what it thinks. It includes three different kinds of meta-cognitive awareness: declarative, procedural, and conditional knowledge. Declarative knowledge refers to knowing “about” things. Procedural knowledge refers to knowing “how” to do things. Conditional knowledge refers to knowing the “why” and “when” aspects of cognition.

The knowledge of cognition may be classified into three components. Meta-cognitive knowledge, which is also called meta-cognitive awareness, refers to what the system knows about itself as a cognitive processor. Meta-cognitive regulation is the regulation of cognition and learning experiences through a set of activities that help the system control its learning. This may be based on its understanding of its own “knowledge gaps.” Meta-cognitive experiences are those experiences that have something to do with the current, on-going cognitive endeavors, e.g., current mission or goals.

The nature of meta-cognition is to understand the structure of the ACNF 300 cognitive processes, i.e., the ability to think about what the system is thinking. The beginnings of meta-cognition are founded in understanding each action the ACNF 300 might take. Within the APC 332, each action is broken into sub-actions, each of which may have separate and different contexts. This contextual knowledge, carried within the cognitive perceptrons, provides the APC 332 with self-awareness and self-assessment processes. This contextual knowledge is relevant to an autonomous system because an activity may be performed in order to satisfy a given contest. Hence, it may also be measured and validated against a specific context to determine the contextual growth over time relative to a given threshold. Therefore, a systems meta-cognitive knowledge is grown based upon individual contexts, recombinantly gathered via meta-cognitive regulation and experiences.

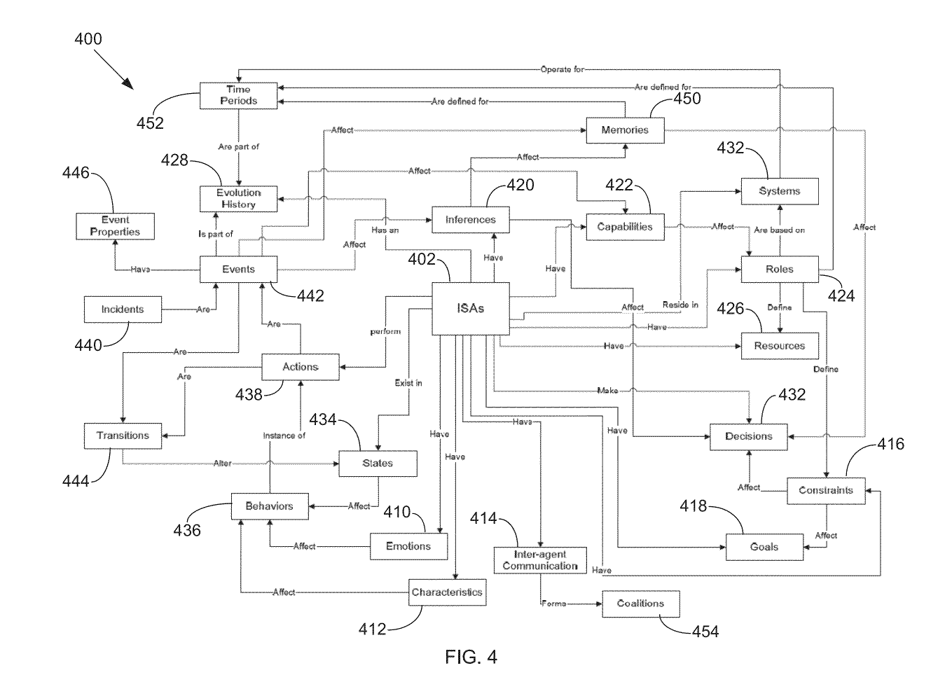

FIG. 4 illustrates a cognitive perceptron ISA ontology 400 according to an embodiment. In FIG. 4, the ACNF cognitive perceptron ISA ontology 400 shows how the cognitive perceptrons are intended to function within the ACNF. The ISAs 402 have emotions 410, characteristics 412, inter-agent communication 414, constraints 416, goals 418, inferences 420, capabilities 422, roles 424, resources 426 and an evolution history 428. The ISAs 402 perform actions 438 and resides in systems 432.

The ISA may exist in a particular cognitive state 434. The cognitive states 434 affect behaviors 436. Behaviors 436 are also affected by the emotions 410 and the characteristics 412. The ISAs 402 perform actions 438 which are instances of behaviors 412. Incidents 440 and actions 438 form events 442. Events 442 and actions 438 represent transitions 444 that alter the cognitive states 434. Events 442 have event properties 446. The events are a part of the evolution history 428. The events 442 also affect memories 450, inferences 420 and capabilities 422. The inferences 420 in turn affect the memories 450 and decisions 452 that are made by the ISAs 402. The decisions are also affected by the constraints 416 and the memories 450. The constraints 416 further affect the goals 418. The roles 424 are affected by the capabilities 422. The roles 424 define the resources 426 and the constraints 416. The roles are also defined for time periods 452. The systems 432 are based on the roles 424 of the ISAs 402. The systems operate for time periods 452 and the memories are defined for time periods 452. The time periods 452 are part of the evolution history 428. The inter-agent communication 414 supports the formation of coalitions 454. The ISAs thus use knowledge ontology to define the particular knowledge domains.

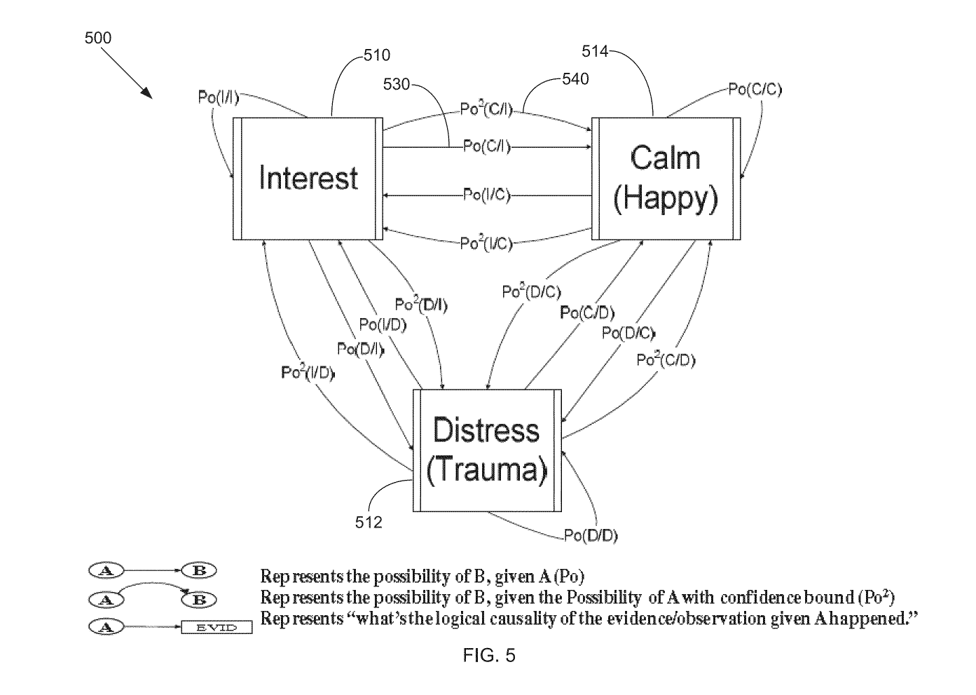

FIG. 5 illustrates an artificial prefrontal cortex (APC) affected state model 500 according to an embodiment. In FIG. 5, the three cognitive states of interest 510, distress (trauma) 512 and calm (happy) 514 are shown. The APC affected state model 500 includes transition probabilities. For example, line 530 transitioning from having interest 510 to a calm (happy) state 514 represents the possibility of transitioning to calm (happy) state 514 given an interest with a probability of Pₒ(C/I). Similarly, line 540 transitioning from having interest 510 to a calm (happy) state 514 represents the probability of transitioning to calm (happy) state 514 given the possibility of having interest with a confidence bound of Pₒ²(C/I),

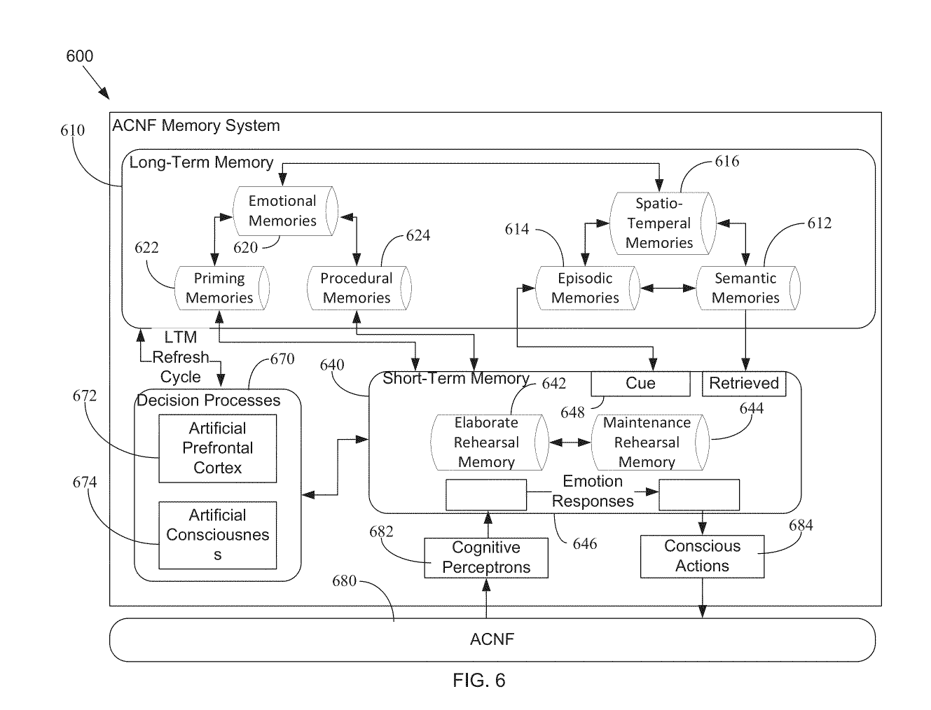

FIG. 6 illustrates the ACNF memory architecture 600 according to an embodiment. FIG. 6 shows long term memory 610, short term memory 640 and the decision processes 670. In order for the ACNF be truly autonomous, the ACNF memory architecture 600 includes the abilities to acquire, categorize, classify, and store information fragments. The purpose of the ACNF memory architecture 600 is to provide the ability to reconstruct/recall information and knowledge, as well as events that have happened in the past. Each memory type has several instantiations, dealing with different types of information and different periodicity.

The sensory memory 680 within the ACNF memory architecture 600 are those memory registers where raw, unprocessed information that comes in through the ACNF environmental sensors is buffered to begin initial processing of the raw data/information. The sensory memory 680 has a large capacity to accommodate large quantities of possibly disparate and diverse information from a variety of sources. Although it has a large capacity, sensory memory 680 has a short duration. Information buffered in sensory memory 680 may be sorted, categorized, turned into information fragments, metadata, contextual threads, and attributes, including emotional attributes, and then sent on to the ACNF short-term memory (STM) 640 for initial cognitive processing.

Based on the information gathered in this initial sensory memory 680, cognitive perceptrons 682 may be generated and initial “thoughts” about the data and hypotheses are generated by the cognitive perceptron 682 and thought-process information, are passed along with the process's sensory information are sent to working memory 640 and the decision processes, e.g., artificial prefrontal cortex 672 and artificial consciousness 674, are alerted.

Short-term memory (STM) 640, e.g., “working” memory, within the ACNF, is where new information is temporarily stored while it is being processed. Short-term memory 640 is where most of the reasoning within the ACNF happens. Short-term memory 640 has two major divisions, called “rehearsals” because the ACNF continually refreshes, or rehearses, these memories while they are being processed and reasoned about, so that the memories do not degrade until they may be sent on to long-term memory 610 and acted upon by the artificial consciousness processes 674 within the ACNF. The elaborate rehearsal memory 642 and the maintenance rehearsal memory 644 are the memories that are continuously refreshed. Emotional responses 646 may be provided to conscious actions 684 for provisioning to the ACNF 680. Short term memories are arranged to cue 648 for access by the long term memory 610.

The ACNF long-term memory (LTM) 610, in the simplest sense, is the permanent place where the ACNF stores its memories, information that is processed in the STM 640 makes it to LTM 610 through the process of rehearsal, processing, encoding, and then association with other memories. Like in the human brain, memories are not stored in databases or in flat files. In fact, memories are not stored as whole memories, but are stored as information fragments. The process of recall, or remembering, constructs memories from these information fragments that are stored in various regions of the ACNF LTM system, depending on the type of information. Within the ACNF storage processes, information fragments are stored in different ways, depending on the type of information. There are three main types of LTM 610: explicit or declarative memories, implicit memories and emotional memories.

Within the ACNF memory architecture 600, memories about emotional situations are often stored in both explicit and implicit LTM systems. Just as the amygdale and hippocampus are involved in implicit and explicit emotional memories, respectively, the ACNF and the coalitions of cognitive perceptrons 682 become emotionally aroused when they form semantic 612 and episodic memories 614 about situations that cause “stress” within an artificial neural system. The semantic memories 612 and the episodic memories 614 are processed with the spatio-temporal memories 616. Stress situations may involve a loss of resources, new data environments that are unfamiliar or new interfaces that are introduced into the environment. These cognitive representations of emotional situations better referred to as memories about emotions rather than emotional memories.

Emotional memories 620 access priming memories 622 and procedural memories 624. Priming memories 622 and procedural memories 624 are coupled to the STM 640. The In human emotions, emotional arousal often leads to stronger memories. This is a statement about explicit memories involving emotional situations, i.e., memories about emotions. The effects of emotional arousal on explicit memory are due to processes that are secondary to the activation of emotional processing systems in the ACNF. For example, in a situation of danger, e.g., in an artificial neural system controlling a weapon system, processing of threatening environment stimuli may lead to the activation of the active cognitive emotion agents within the ACNF, which, in turn, may transmit information to neural structures within the infrastructure of the system and system network. Activity in these areas may be detected by the cognitive coalitions and may lead to increases in system emotional arousal, e.g., due to activation of modulation within the neural structure that leads to the release of cognitive problem, solution, search, and emotion agents. The transmittal of informational content as well as emotional context allows information construction/retrieval performance to be greatly enhanced, allowing for “cognitive economy” within the artificial neural systems.

Within the ACNF memory are four distinct processes that are handled within the STM 610 that determine where information is transferred after cognitive processing. These are information fragment encoding, information fragment selection, information fragment organization and information fragment integration,

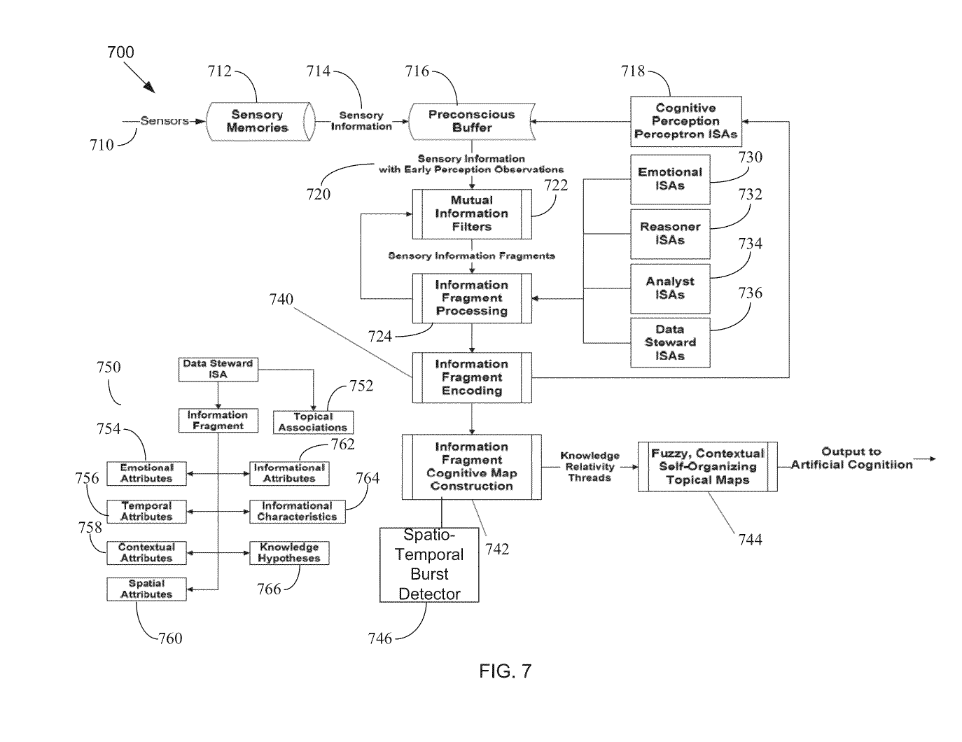

FIG. 7 illustrates information fragment encoding within the ACNF 700 according to an embodiment. The information fragment encoding creates a small, information fragment cognitive map that will be used for the organization and integration memories within the ACNF

information fragment selection involves filtering the incoming information 710 obtain from sensors and placed in sensory memories 712. The sensory information 714 is provided to preconscious buffers 716. The preconscious buffers 716 also receive information from the cognitive perceptrons and perception ISAs 718. Separable information fragments with early perception observations 720 are provided to the mutual information filters 722. Sensory information fragments 724 are provided to the information fragment processing 724. The information fragment processing 724 receives input from the emotional ISAs 730, reasoner ISAs 732, analyst ISAs 734 and data steward ISAs 736. The information fragment processing 724 may provide feedback to the mutual information filters 722.

The information fragment processing 724 provides processed information fragments to the information fragment encoding 740. Each information fragment includes a data steward ISA 736 that manages the memory encoding information by the information fragment encoding 740. This includes a cognitive map as described below. The arrangement of the information fragment with the data steward ISA 750 includes topical associations 752, emotional attributes 754, temporal attributes 756, contextual attributes 758, spatial attributes 760, informational attributes 762, informational characteristics 764 and knowledge hypotheses 766.

Information fragment organization processes within the ACNF create additional attributes within the information fragment cognitive map 742 that allow it to be organized for integration into the ACNF LTM framework. Cognitive map construction 742 includes creation of memory recall characteristics including spectral characteristics, temporal characteristics, spatial characteristics, knowledge relativity threads and socio-synthetic emotional threads.

Once the information fragments within the STM have been encoded, information fragment integration occurs via fuzzy, contextual self-organizing topic maps 744, wherein the information fragments are compared, related, and attached to larger, topical cognitive maps that represent relevant subject or topics within the ACNF LTM system.

One of the major functionalities within the STM attention loop is the spatio-temporal burst detector 746. Here, information fragments are ordered in terms of their spatial and temporal characteristics. Spatial and temporal transitions states are measured in terms of mean, mode, median, velocity, and acceleration and are correlated between their spatial and temporal characteristics and measurements. Rather than just looking at frequencies of occurrence within information, rapid increases in temporal or spatial characteristics may trigger an inference or emotional response from the cognitive processes.

State transitions bursts are ranked according to their weighting, e.g., velocity and acceleration, together with the associated temporal and/or spatial characteristics, and any emotional triggers that might have resulted from this burst processing. The burst detection and processing of the spatio-temporal burst detector 746 may help to identify relevant topics, concepts, or inferences that may need further processing by the artificial prefrontal cortex and/or cognitive consciousness processes.

Once processing within the STM system has completed and memories are encoded, mapped to topical associations, and their contexts captured, representations are created and sent on to the memory integration processes, and memories that are deemed relevant to “remember,” are integrated into past memories and then stored in one of the long term memory systems. The integrated memory information is sent back into the cognitive perceptron processes 7748 to provide a complete picture of current knowledge about the incoming sensory information.

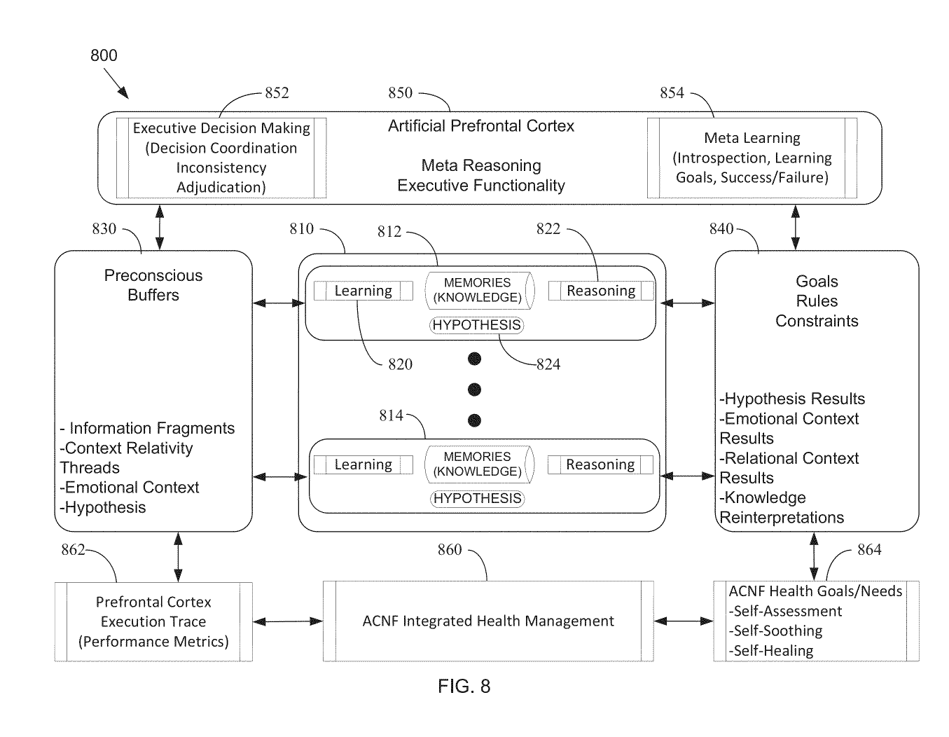

FIG. 8 illustrates learning management within the ACNF 800 according to an embodiment. In FIG. 8, memories 810 are operatively disposed between preconscious buffers 830 and the goals, rules and constraints 840. The memories 810 include separate cognitive units 812, 814, which include learning 820, reasoning 822 and a hypothesis 824.

Learning within the ACNF denotes changes in the system that enable the ACNF to perform new tasks previously unknown, or to perform tasks already learned more accurately or more efficiently. Learning is constructing or modifying representations of what the ACNF is experiencing. Learning also allows the ACNF to fill in skeletal or incomplete information or specifications about a domain (self-assessment).

The ACNF, or any complex, AI system, cannot be preloaded, or trained. Autonomous and dynamic updating (learning) is used to incorporate new information into the system. Learning new characteristics expands the ACNF's domain or expertise and lessens the brittleness of the systems.

Preconscious buffers 830 are used to store information fragments, context relativity threads, emotional context and hypotheses. The goals, rules and constraints 840 include hypotheses results, emotional context results, relational context results and knowledge reinterpretations.

The artificial prefrontal cortex 850 provides meta-reasoning and executive functionality. Executive decision 852 handles decision coordination and inconsistency adjustication. Meta learning 854 handles introspection, learning goals, and success/failure reasoning. In FIG. 8, ACNF integrated health management 860 is provided. The ACNF integrated health management 860 is operatively coupled between the prefrontal cortex execution trace (performance metrics) 862 and the ACNF health goals/needs 854. The ACNF health goals/needs 854 provides for self-awareness, self-soothing and self-healing. The prefrontal cortex execution trace (performance metrics) 862 interfaces with the preconscious buffers 830. The ACNF health goals/needs 864 interfaces with the goals, rules and constraints 840.

There are multiple learning systems within the ACNF including rote learning, induction involves extrapolating, abduction, clustering, probably, approximately correct (PAC) learning, Occam learning and emotional Learning.

Rote learning is also called “learning-by-memorization.” This is an associative implicit memory that carries rote information that may be used by the ACNF. Induction involves extrapolating from a given set of examples so that the ACNF may make accurate predictions about future examples. Abduction involves the generation of populations of hypotheses by genetic algorithms and implementation of a dialectic argument (Toulmin) structure, which are used to reason about and learn about a given set of information or situations, also called concept learning. Clustering is related to pattern recognition. Probably, approximately correct (PAC) learning assumes information attained is from an unknown distribution of information about a particular topic. The assumption is that what is learned, based on the current information, provides an approximately correct basis for new data or information not yet encountered. However, the probably, approximately notion denotes that it is expected that what is learned, or remembered about the information, may be updated as new information is attained. Occam learning is associated with a learning system, taken from William of Occam, and is called “Occam's Razor.” Occam learning is often sited to justify one hypothesis over others, and is taken to be “a preference for simpler explanations.” The more the data is compressed, i.e., the more complex the learning algorithm, the more likely something subtle is missed or eliminated. Reasoning from this perspective, an Occam learning algorithm produces hypotheses, or pattern discoveries that are simple in structure, and grow slowly as more data are analyzed. Emotional Learning provides “personality” parameters and conscious cognitive perceptrons that provide sensitivities to emotional computation and to situational analysis. The emotional learning responses and emotional action responses are computed from the cross-connectivity of the recombinant, genetic neural fiber threads, based on the autonomic nervous system states. Emotional learning responses are computed from the column-wise fuzzy weightings and emotional action response are computed from the row-wise fuzzy weightings.

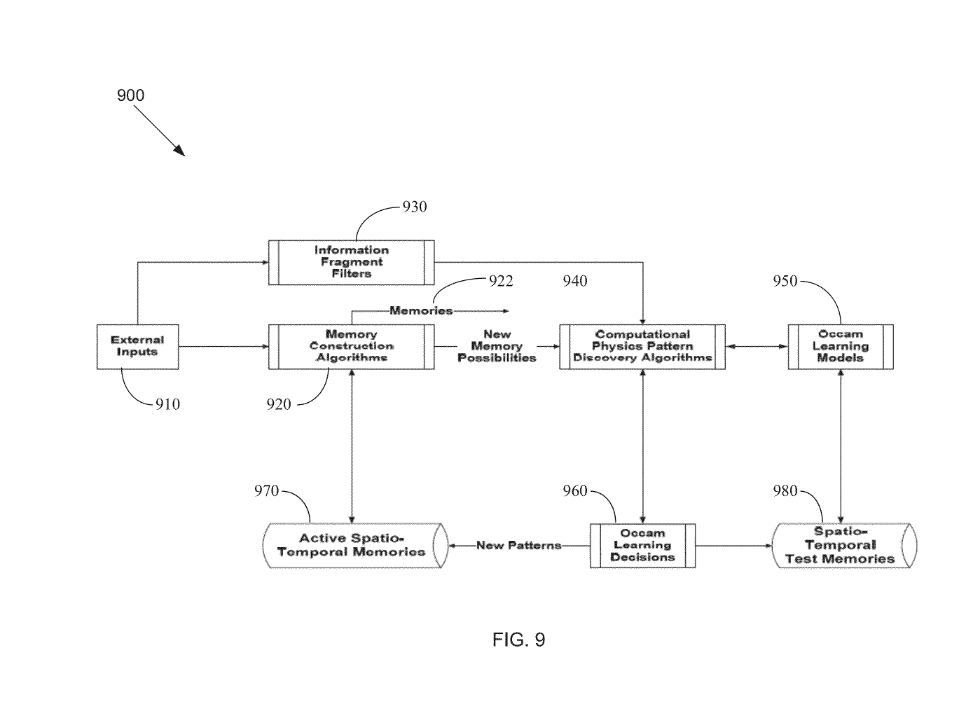

FIG. 9 illustrates an Occam learning environment 900 according to an embodiment. In FIG. 9, external inputs 910 are provided to memory construction algorithms 920 and to information fragment filters 930. The memory construction algorithms 920 provide information fragments to memories 922. New memory possibilities are provided from the memory construction algorithms 920 to the computational physics pattern discovery algorithm 940. The computational physics pattern discovery algorithm 940 interfaces with the Occam learning models 950 and the Occam Learning decisions 960. Active spatio-temporal memories 970 is operatively disposed between the memory construction algorithms 920 and the Occam Learning decisions 960. The Occam learning decisions 960 provides new patterns to the active spatio-temporal memories 970. Spatio-temporal test memories 980 are operatively disposed between the Occam learning modules 950 and the Occam Learning decisions 960.

The recombinant knowledge assimilation framework follows the dynamic properties of human cognition and physically implements them as a cognitive foundational architecture. By its nature it is designed not just with multi-dimensional concepts but with n-dimensional concepts in mind. Specifically, researched were the concepts of particle physics which deals with n-dimensional problems, as well as, the theories of Henry Lorentz, specifically Lorentzian manifolds. Very specifically, in Hibbeler dynamics, the properties of moving particles together with the concepts of particle perspective abstraction relative to the context perspective of different users. Mature physics applications of quantum relationships where everything may be related to another based upon perspective is abstracted to the use of context and the associated relationships to the information content which, when assimilated into knowledge, adds or subtracts from the derived context. The context perspective of the individual researcher may be different when working on an identical problem. Therefore, complex, multi-dimensional data problems are addressed with flexible, multi-dimensional, mature mathematics from the physics and computational mechanics domains.

The ACNF architecture recombinantly assimilates knowledge from any type. The understanding of two fundamental concepts, the concept of representation and the subtle difference between it and presentation and formats are defined by their creators for a number of reasons, either with forethought of how to convey thoughts to themselves or to others provides a basis for recombinantly assimilate knowledge.

Clinical psychologists refer to the storage of this representation in memory. Therefore, at each core structure of a simple thought or complex concept, the context comes from the creator and is embedded within the output of the end product. This may be lost in translation. For example, the onset of extensible markup language (XML) and the development of resource description framework (RDF) and web ontology language (OWL) has been a great tool for mapping information into formats which systems may easily access and understand. However, although some are better than the other, most knowledge is translated into these formats with extreme loss of context and most definitely with the loss of pedigree, which is used to capture context as well.

Therefore, a number of attributes of the architecture capture this context and pedigree. This was not a simple task and work still remains to be done. Secondly, the concept of presentation is also context driven and is a subtle difference from representation, but usually the mechanism for cognitively interacting with the information so that not only the information is understood, but may be conveyed to someone else. Thus, this is the reason for implementing the ability to watch the neural framework develop over time. In this way, divergence and convergence to context may be interacted with dynamically to more quickly achieve a predetermined result.

Fundamentally within the processes that recombinantly assimilate information content into knowledge, there is no concept of error or non-error. There exists only information content. Therefore, the concept of errors is itself erroneous to the architecture. This sounds somewhat blasphemous, but is exactly why the system works the way it does. The ACNF has agents or bots which monitor the system for convergence and divergence from a given context and provide qualitative insight into the processes which monitor the system as a type of sensor. These agents monitor the constant evaluation and reevaluation of new information con as it is absorbed or assimilated into the system. Therefore, as the system autonomously devours information, constraints are embedded in the architecture to provide some limitations. The difficulty with constraints is that each specific context may have different constraints based upon factors specific to the information being processed and the dynamically changing context itself. This is the reason for the adaptation and storage of evaluating positive and negative outcomes through the use of positive and negative perceptrons. These outcomes are also a form of context and may become less diverse and more mainstream definitions of good and bad as the system learns what bad and good are.

Accordingly, the ACNF according to an embodiment provides the meta-cognitive and meta-memory (artificial prefrontal cortex), self-assessment and self-reasoning, mechanisms that may be used for systems to be truly autonomous. The cognitive abilities for a fully-autonomous system may include the abilities to infer and reason about concepts and situations that the system has not encountered before. The dialectic search structures, along with the Occam learning, driven by computational mechanics concepts, provide the ACNF with the ability to formulate new hypotheses about data, information, and situations not previously encountered by the system. These self-discovery mechanisms are used when a system is to be truly autonomous.

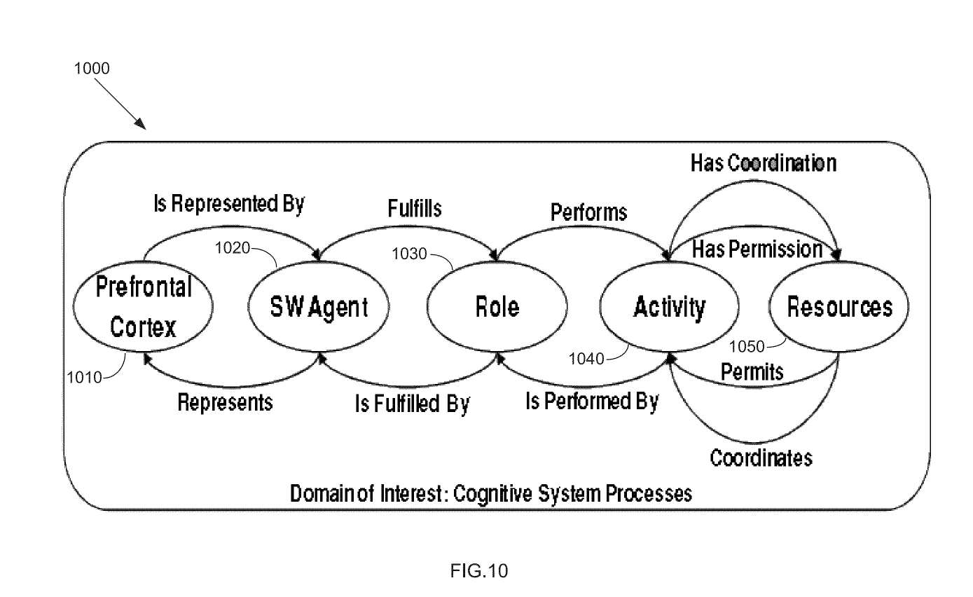

FIG. 10 illustrates the artificial prefrontal cortex (APC) inference flow 1000 according to an embodiment. The APC artificial prefrontal cortex is implemented or instantiated with intelligent information software agents. The APC provides governance capabilities that enable definition and enforcement of cognitive policies governing the content and usage of the cognitive and topical maps by the intelligent software agent framework across the AI enterprise.

In FIG. 10, the prefrontal cortex 1010 is represented by a software agent 1020. The software agent 1020 fulfills a role 1030. The role 1030 performs and activity 1040. The activity 1040 has coordination of and permissions regarding resources 1050. However, the flow may also proceed in the opposite directions, wherein the resources 1050 permit and coordinates the activity 1040. The activity 1040 is performed by the role 1030. The rote is fulfilled by the software agent 1020. The software agent 1020 is represents the prefrontal cortex 1010.

The functions carried out by the APC 1010 may be described as executive functions. Executive functions relate to abilities to differentiate among conflicting thoughts, determine good and bad behavior, better and best, same and different, future consequences of current activities, working toward a defined goal, prediction of outcomes, expectation based on actions, and social control. The APC 1010 is involved with top-down processing. Top-down processing by definition is when behavior is guided by internal states or intentions. These are driving toward the cognitive concept of “mindfulness,” Mindfulness is an awareness for seeing things as they truly are without distortion or judgment.

In order for AI systems to be truly autonomous, the executive function abilities are used. One of the cognitive concepts that will be used for a truly autonomous system is the ability to perform top-down processing, which may include the AI taking an understanding of the mission or task at hand, from this defining goals and prediction of outcomes, and utilizing this knowledge to define the system behaviors used to meet the mission or task goals. An autonomous AI system uses executive management and strategic knowledge. The executive management autonomous system processes involve planning, monitoring, evaluating and revising the system's own cognitive processes and products. Strategic knowledge involves knowing what tasks or operations to perform, e.g., factual or declarative knowledge, knowing when and why to perform the tasks or operations, e.g., conditional or contextual knowledge, and knowing how to perform them, e.g., procedural or methodological knowledge. Both executive management and strategic knowledge capabilities enable the system to autonomously self regulate its own thinking and learning.

The APC is provided as part of an overall ACNF for real AI autonomous system control. A hidden Markov model of an APC uses fuzzy possibilistic logic to drive the system between cognitive states is described.

As knowledge and cognitive context increases within the AI system, a formal framework for dealing with increasing and decreasing levels of cognitive granularity is used to learn, understand, and store the closeness of cognitive relationships. These abilities are handled utilizing a hybrid, fuzzy-neural processing system with genetic learning algorithms. This processing system uses a modular artificial neural architecture based on a mixture of neural structures with intelligent software agents that add flexibility and diversity to the overall system capabilities. To provide an artificially intelligent processing environment, the system may possess the notion of artificial emotions, which allow the processing environment to react in real-time as the systems environment changes and evolves. This hybrid fuzzy-neural processing framework is referred to as the artificial cognitive neural framework (ACNF), which was described above.

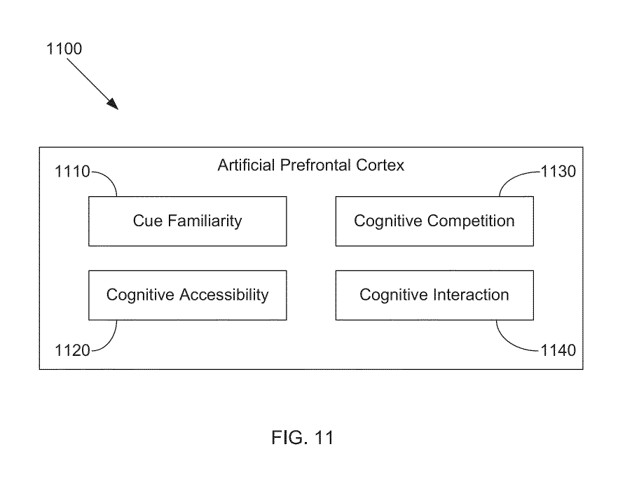

FIG. 11 illustrates capabilities of the artificial prefrontal cortex 1100 according to an embodiment. Detecting cognitive process information within the ACNF begins with sensors that capture information about the system's physical or cognitive state or behavior. As described above with regard to the ACNF, the information is gathered and interpreted by the cognitive perceptrons similar to how humans utilize cues to perceive cognitive states or emotions in others. The APC 1100 provides the possibilistic inferences for the system to transfer between cognitive states. The APC 1100 makes it possible to transition between cognitive states at any instant, and transition between these states with certain possibilistics. Possibilistic parameters evolve over time, and are driven by the learning algorithms and how they affect both normal and emotional memories. These cognitive state transition conditional possibilistics provide the APC 1100 with the ability to make executive-level plans and move between cognitive states, each of which has its own set of priorities, goals, and motivations. The impetus for the APC 1100 is to create a truly autonomous AI system that may be used in a variety of applications like UAVs, intelligence processing systems, cyber monitoring and security systems, etc. In order to accomplish these tasks, the APC 1100 acts on capabilities processes including cue familiarity 1110, cognitive accessibility 1120, cognitive competition 1130, and cognitive interaction 1140.

Cue familiarity 1110 is the ability of the system to evaluate its ability to answer a question before trying to answer it. In cue familiarity 1110, the question (cue), and not the actual memory (target), are used for making cognitive judgments. This implies that judgments regarding cognitive processing and decisions may be based on a level of familiarity of the system with the information provided in the cue. This executive-level, top-down cognitive judgment is based on APC abilities that allow the AI system to judge whether they know the answer to a question, i.e., is the system familiar with the topic or mission, allowing the system to judge that they do not know the answer to a question which presents new or unfamiliar terms or conditions.

Cognitive accessibility 120 suggests that the system's memory will be more accurate when the ease of cognitive processing (accessibility) is correlated with memory behavior (emotional memory). This implies that the quality of information retrieval depends on the system's density of knowledge on the topic or subject, or individual elements of informational content about a topic, since the individual elements of topical information may differ in strength. The speed of access is tied to both density of knowledge and emotional memory responses to the information.

Cognitive competition 1130 may be described as three principles. The AI cognitive processing system (the brain) is activated by a variety of inputs (sensors). There is textual, audio, and visual (picture and video) information that compete for cognitive processing access. Competition occurs within the multiple cognitive processing subsystems and is integrated by the intelligent software agents between the various cognitive processing subsystems. Competition may be assessed utilizing top-down neural priming within the APC, based on the relevant characteristics of the object at hand.

Cognitive interaction 1140 combines cue familiarity 1110 and cognitive accessibility 1120. In cognitive interaction 1140, once cue familiarity 1110 fails to provide enough information to make cognitive inferences, cognitive accessibility 1120 in employed access extended memories and may employ stored emotional memory cues to access information to make the cognitive inferences. This may result in slower response time that with cue familiarity 1110 alone.

To provide the APC 1100 with capabilities described above, processing constructs are used to allow cognitive inferences to be made, based on the information received, inferences and decisions learned, and an overall sense of priorities, goals, and needs.

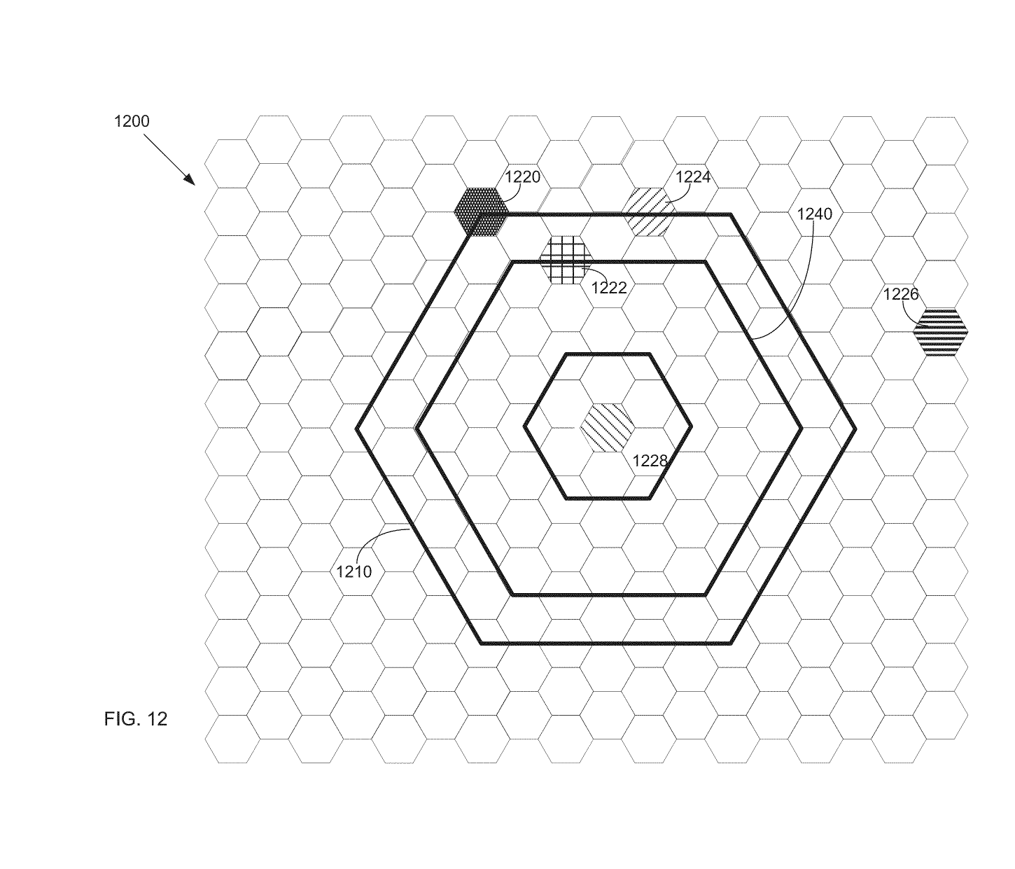

FIG. 12 illustrates a fuzzy, self-organizing, contextual topical map (FSOCTM) 1200 according to an embodiment. The FSOCTM 1200 is a general cognitive method for analyzing, visualizing, and providing inferences for complex, multi-dimensional sensory information, e.g., textual, auditory, and visual. The FSOCTM is actually built on two, separate, fuzzy, self-organizing topical maps. The first is a semantic fuzzy, self-organizing, map FSOM that organizes the information semantically into categories, or topics, based on the derived eigenspaces of features within the information. The FSOM shows information and topical “closeness” search hits. The larger hexagons 1210 denote topical sources that best fit the search criterion. The isograms 1210 denote how close the hits 1220, 1222, 1224, 1226, 1228 are to a particular cognitive information topic, for example, topic 1 1240.

The FSOM information and topical closeness map has several attributes of interest. Image processing algorithms may be utilized to analyze the output of the FSOM. Searches use contextual information to find cognitive links to relevant memories and information available. The FSOM is self-maintained and automatically locates input from relevant Intelligent Software Agents and operates unsupervised.

The high-level topical spaces are compared, within the APC, to identifiable eigenmoods within the emotional memory. The resulting eigenspaces determine topics 1240 that are compared within the contextual FSOM to look for closeness of topics 1240 to be used in cognitive processing algorithms to determine the cognitive state that will be used to make inferences about the question or task being posed. The eigenspaces are estimated under a variety of emotional memory conditions and their dependencies on external inputs and cognitive actors determined. Eigen trajectories are then characterized to capture the dynamic aspects of relationships between topical closeness and the information and memories available.

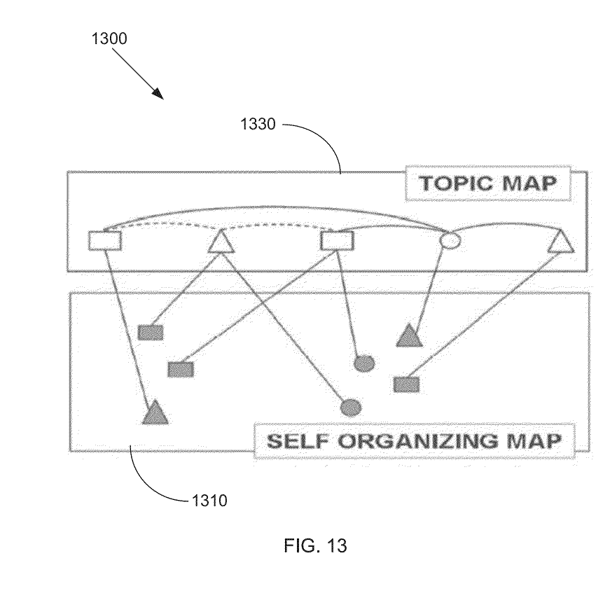

FIG. 13 illustrates the superimposition of two maps 1300 to form a fuzzy, self-organizing, contextual topical map according to an embodiment. In FIG. 13, a fuzzy, self-organizing map 1310 is merged with a fuzzy, self-organizing, contextual topical map (FSOCTM) 1330. Once the FSOM 1310 is created, the resultant topical eigenspaces are mapped to the FSOCTM 1330 to show cognitive influences and ties to cognitive processes and other memory information.

The value of superimposing the FSOCTM 1330 onto the SOM 1310 is that it defines the cognitive information domain's ontology, and enables the use of a topic map query language (TMQL) within the APC. The topic map 1330 enables end APC to rapidly search information conceptually. It also enables sophisticated dialectic searches to be performed for them.

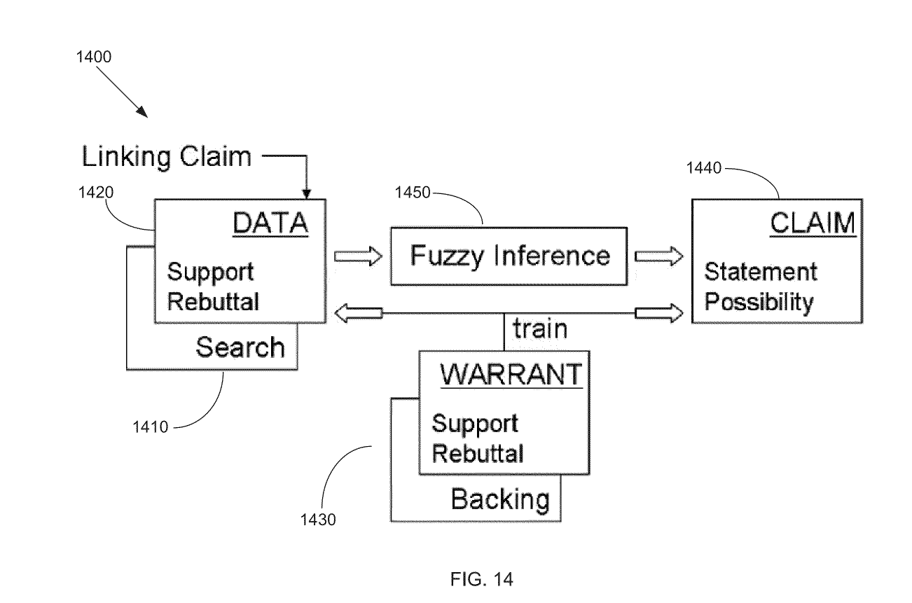

FIG. 14 illustrates a structure for a dialectic search argument (DSA) 1400 according to an embodiment. The dialectic search 1410 uses the Toulmin argument structure to find and relate information and memories to develop a larger argument, cognitive inference. The dialectic search argument (DSA) includes information and memories 1420 to support and rebut the argument or hypothesis under analysis by the APC. The information and memories 1420 provide data for support and rebuttal. Warrant and backing 1430 is used to explain and validate the hypothesis. The claim 1440 defines the hypothesis itself using a statement and possibilities. Fuzzy inference 1450 relates the information/memories to the hypothesis.

The dialectic search serves two purposes. First, it provides an effective basis for mimicking human reason. Second, it provides a means to glean relevant information from the topic map and transform it into actionable cognitive intelligence. These two purposes work together to provide an intelligent system that captures the capability of the human reasoning to sort through diverse information and find clues based on cue familiarity discussed above. This approach is considered dialectic in that it does not depend on deductive or inductive logic, though these may be included as part of the warrant 1430. Instead, the dialectic search depends on non-analytic inferences to find new possibilities based upon warrant examples. The dialectic is dialectic because its reasoning is based upon what is plausible; the dialectic search is a hypothesis fabricated from bits of information fragments (memories) put together utilizing the topical maps and eigenspaces.

Once the available information has been assimilated by the dialectic search, information that fits the support and rebuttal parameters is used to instantiate a new claim 1440 (or hypothesis). This claim 1440 is then used to invoke one or more new dialectic searches 1410. The developing lattice forms the reasoning that renders the cognitive intelligence lead plausible and enables the possibility to be measured and cognitive inferences made within the APC.

The approach to cognitive intelligence inferencing within the APC is threefold. The FSOCTM is investigated to semantically organize the diverse information collected and retrieved from memory. The map produced by the FSOM is utilized to enhance the APCs comprehension about the situations under analysis. As the APC traverses the map to find related and relevant events, the results are used to create cognitive clues that are stored in the emotional memory for use under similar circumstances.

This approach mimics human intelligence, learning from intelligent software agents using knowledge ontology to define particular knowledge domains (topics), having experts (intelligent information software agents) to cartographically label the FSOM to capture the meaning of the integrated information thus capturing the knowledge of each cognitive inference.

Mimicking human intelligence demands a polymorphic architecture that is capable of both hard and soft computing. The APC with the FSOCTM, soft computing, and utilizing the ACNF framework provides a structure that allows the APC to evolve and grows as it learns more about its environment. Streams of diverse information are processed to provide terse vectors for FSOM and cognitive mapping. This is accomplished through the use of the genetically evolving ACNF processing network.

The FSOM ensures the results may be readily understood by the APC. The FSOM collapses multiple dimensions in information onto 2-dimensional space, which is a form that may be more easily computed and understood by the APC, especially when it has been enhanced to include emotional memory information. As more information is acquired, it is mapped into an already understood structure within the ACNFs structure,

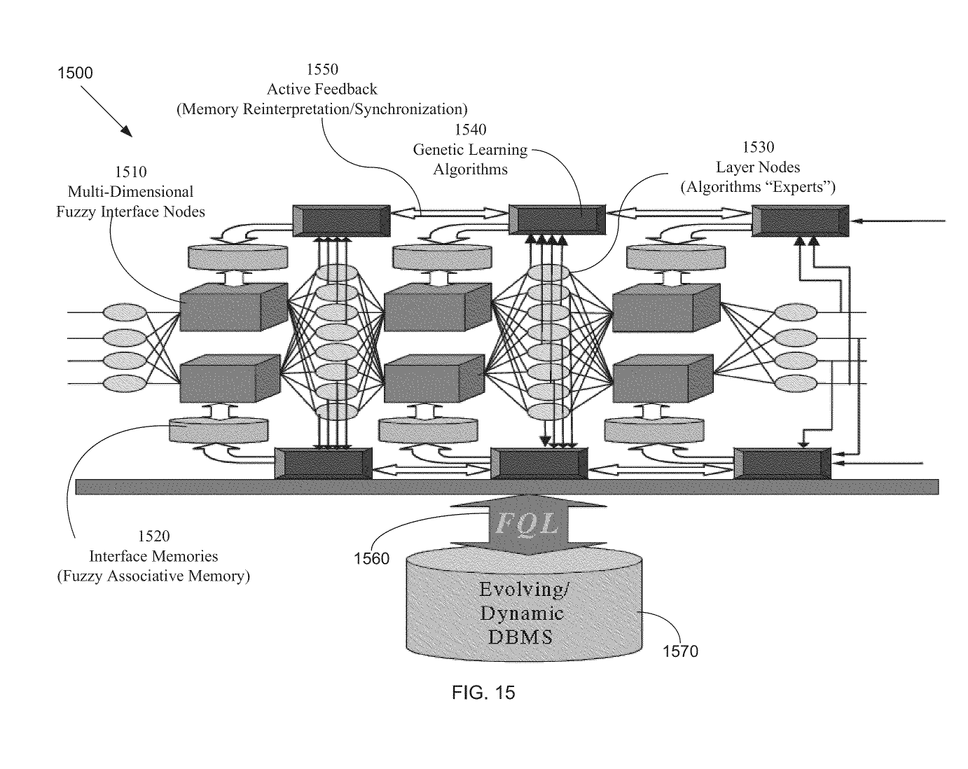

FIG. 15 illustrates an evolving, life-like yielding, symbiotic environment (ELYSE) architecture 1500 according to an embodiment. The ELYSE architecture 1500 is composed of four main processing blocks. Mediators 1510 determine the processing path for the next level of data/information processing. Evolving neural memories 1520 are provided for each of the interfaces.

Algorithm experts 1530 are intelligent software agents that work together to form a massively parallel, highly interconnected network of loosely coupled, relatively simple processing elements in a hybrid fuzzy, genetic neural system of “M” experts architecture. Evolutionary learning blocks 1540 provide learning and feedback/feed forward for the system. The mediators 1510 provide a multi-dimensional fuzzy interface node between the evolving neural memories 1520. The evolving neural memories 1520 may include fuzzy associative memory. Active feedback 1530 for memory reinterpretation and synchronization is provided between the learning blocks 1530. Fuzzy queue logic 1560 interfaces the ELYSE architecture 1500 with an evolving dynamic database management system (DBMS) 1570.

There are many situations where a neural network may be capable of learning and adapting to its changing environment, such as such as integrated system health management, automated target recognition, data retrieval, data correlation and processing, etc. In the neural community, the problem of realizing a time-varying mapping of neural structures is commonly referred to as the sequential learning problem. Neural systems based on this principle tend to forget previously learned neural mappings quickly when exposed to new types of data environments, a phenomenon known as catastrophic interference (CI). There have been attempts to alleviate CI by reducing the coupling, or unlearning, in such networks or by using networks with localized processing responses, i.e., a neural structure is added at the local level, not at the global level. Unfortunately, these types of systems can lead to unbounded growth due to a lack of an efficient pruning mechanism.

The ELYSE architecture 1500 is a modular architecture that provides a flexible, continually adaptable neural (processing system capable of dynamically adding and pruning basic building blocks of the neural system as the real-time parameters of the system change. The ELYSE architecture 1500 is based on a mixture of neural structures that add flexibility and diversity to the overall system capabilities. The ELYSE architecture 1500 is a flexible, continually adaptable neural processing system that provides the capability of dynamically adding and pruning basic building blocks of the neural system as the real-time parameters of the system change. The network-learning blocks extend the neural architecture, thereby creating a continuously evolving processing environment where parts of the network form a symbiotic system. The ELYSE architecture 1500 is adaptable to a variety of classes of applications, e.g., language processing, signal detection, sensor fusion, inductive and deductive inference, robotics, diagnosis, etc.

The ELYSE architecture 1500 involves an artificial cognitive neural framework (ACNF) that contains fuzzy, neural intelligent information agents called cognitive perceptrons. Each perceptron is accomplished by codelets, small pieces of code that each performs one specialized, simple task. Codelets often play the role of waiting for a particular type of situation to occur and then acting as per their specialization. These perceptron codelets are themselves miniature fuzzy-neural structures with specific purposes accomplished through tight constraints, but have the ability to learn and evolve. As mentioned earlier, they have short and long-term memories and have the ability to communicate with other codelets. In human cognitive theory, the codelets may be thought of as cell assemblies or neuronal groups.

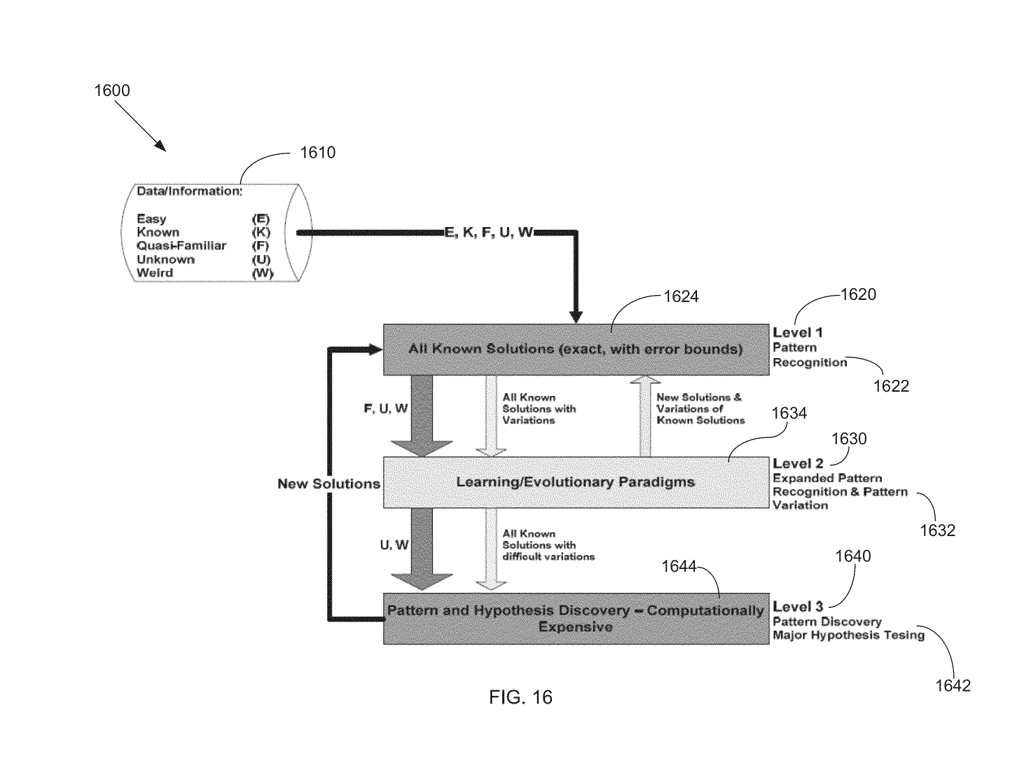

FIG. 16 illustrates an evolving, life-like yielding, symbiotic environment (ELYSE) processing framework 1600 according to an embodiment. Data and information 1610 are provided to level 1 1620 to perform pattern recognition 1622. Level 1 1620 includes known solutions 1624. Level 1 1620 identifies patterns of behavior that have been seen before, or that behave in a similar, fuzzy relational way. Level 1 1620 communicates with level 2 1630, which provides an expanded pattern recognition and pattern variation process 1632. The expanded pattern recognition and pattern variation process 1632 of level 2 includes pattern discovery algorithms providing learning/evolutionary paradigms 1634 that augment patterns that are similar to known patterns but need additional information to describe the pattern divergences. Level 2 1630 communicates with level 3 1640, which provides pattern discovery and major hypothesis testing 1642. Thus, level 3 1640 provides a full up pattern discovery paradigm 1644 to make sense of information that has not been previously described, e.g., determines how to find things it didn't know it was looking for.

Theory into human consciousness postulates that human cognition is implemented by a multitude of relatively small, well-defined purpose processes, which may be unconscious. These processes are autonomous and narrowly focused. They are efficient, high speed, and make very few errors because their purpose is narrowly focused. Each of these human processes may act in parallel with others.

The ELYSE processing framework 1600 is considered a mixture-of-experts architecture because it allows dynamic allocation of cognitive perceptrons through a divide-and-conquer principle. The neural infrastructure employs genetic programs which possibilistically “softly” divide the input space into overlapping regions on which the perceptron “experts” operate. Assuming at time t, there are M local perceptron experts at any given subsystem level of ELYSE. Each of the NI experts looks at a common input vector x to form an output, ŷ(x)gⱼ(x), j=1 . . . M, wherein gⱼ(x) is a gating function which weights outputs of the perceptron experts form an overall output:

ŷ=Σⱼyⱼgⱼ(x).

The localized gating model, based on Ramamerti's model, is:

$${ɛ}_{N}^{°} ( z ) = {\sum }_{n = 0}^{n = N} {z}^{n} {J}_{n} ( {( 1 )}_{[ 1 , N ]}^{° n} = {\sum }_{n = 0}^{n = N} {z}^{n} {\sum }_{d = 0}^{d = N} {\sum }_{{1 \leq {i}_{1} < … {i}_{d}}_{{n}_{1} + … + {n}_{d} = n}}^{ } \frac{n !}{{n}_{1} ! … {n}_{d} !} {\prod }_{k = 1}^{k = d} {ϕ}^{{n}_{k}} ( {S}_{{i}_{k}} ( {S}_{{i}_{k}} \vert {S}_{{i}_{k} - 1} ) , \\ z ∈ R$$

where:

$$P ( x \vert {v}_{j} ) = {( 2 π )}^{- \frac{n}{2}} {\vert {\sum }_{j}^{ } \vert}^{- 1 / 2} {e}^{\{ - 0.5 {( x - {m}_{j} )}^{T} {\sum }_{j}^{1} ( x - {m}_{j} ) \}} ,$$

Thus, the jth perceptron expert's influence is localized to a region around m, with its width determined by Σⱼ. The formulation for estimating the perceptron expert network parameters is given by:

$${h}_{j}^{( k )} ( {y}^{( t )} \vert {x}^{( t )} ) = \frac{{g}_{j}^{( k )} ( {x}^{t} , v ) {e}^{\{ ( - 0.5 {( y - {\hat{y}}_{j} )}^{T} ( y - {\hat{y}}_{j} ) \}}}{{\sum }_{i}^{ } {g}_{i}^{( k )} ( {x}^{t} , v ) {e}^{\{ ( - 0.5 {( y - {\hat{y}}_{j} )}^{T} ( y - {\hat{y}}_{i} ) \}}}$$

$${α}_{j}^{( k + 1 )} = \frac{1}{N} {\sum }_{t}^{ } {h}_{j}^{( k )} ( {y}^{( t )} \vert {x}^{( t )} )$$

$${m}_{j}^{( k + 1 )} = \frac{1}{{\sum }_{t} {h}_{j}^{( k )} ( {y}^{( t )} \vert {x}^{( t )} )} {\sum }_{t}^{ } {h}_{j}^{( k )} ( {y}^{( t )} \vert {x}^{( t )} ) {x}^{t}$$

$${\sum }_{j}^{( k + 1 )} = \frac{1}{{\sum }_{t}^{ } {h}_{j}^{( k )} ( {y}^{( t )} \vert {x}^{( t )} )} {\sum }_{t}^{ } {h}_{j}^{( k )} ( {y}^{( t )} \vert {x}^{( t )} ) [ {x}^{( t )} - {m}_{j}^{k} ] [ {x}^{( t )} - mjk ] T$$

$${θ}_{j}^{k + 1} = arg {θ}_{j}^{min} {\sum }_{t}^{ } {h}_{j}^{( k )} ( {y}^{( t )} \vert {x}^{( t )} ) ‖ y - {\hat{y}}_{j} ‖$$

$${θ}_{j}^{k + 1} = arg {θ}_{j}^{min} {\sum }_{t}^{ } {h}_{j}^{( k )} ( {y}^{( t )} \vert {x}^{( t )} ) ‖ y - {\hat{y}}_{j} ‖$$

Dynamic allocation of perceptron experts provides complete flexibility in the system as new data classes are encountered within a given data space. In the dynamic system, it is expected that growing and pruning changes are slow with respect to time, since the decision to add complexity or remove capability may be based on information that has been learned over many iterations of the system. The dynamic error estimate for perceptron expert is:

E_{j,t+1}=E_{j,t}+λₜ₊₁└(y^{t}−ŷ^{t})−E_{j,t}┘.

If the error estimate corresponding to a particular perceptron expert increases beyond a given threshold, the need for an additional perceptron expert is detected. The dynamic procedure for adding a perceptron expert includes initializing the mean vector corresponding to the new perceptron expert to be equal to the mean vector of the corresponding expert to be split. A small random perturbation is added to the two means. For a window of length T of input classes identified, parametric updates are made to the perceptron experts, except the expert being split and the new perceptron expert. For a window of length T of input classes, if the posterior hⱼ, corresponding to one of the new perceptron experts is the highest among the posteriors of the experts for a given signal class, parameter updates for this perceptron expert is also made. The window length T is chosen in such a way to separate the 2-means space. After this window length of T data samples, the two perceptron experts become part of the mixture-of-experts system. Pruning is performed by monitoring the parameter αⱼ. When αⱼ becomes small, the corresponding perceptron expert is pruned from the system.

In the ACNF, as discussed with reference to at least FIG. 2, first the unconscious artificial neural perceptrons, each working toward a common goal, form a coalition. The architecture for the ACNF that facilitates “conscious” software agents is described below. This framework provides a collection of constraints, building blocks, design elements, and rules for composing a “conscious” agent.

Based on the overall system state, information is broadcast to unconscious processes in order to recruit other artificial neural perceptrons that may contribute to the coalition's goal. The coalitions that understand the broadcast may then take action on the problem. ACNF architecture is responsible for artificial neural emotions and artificial nervous system states.

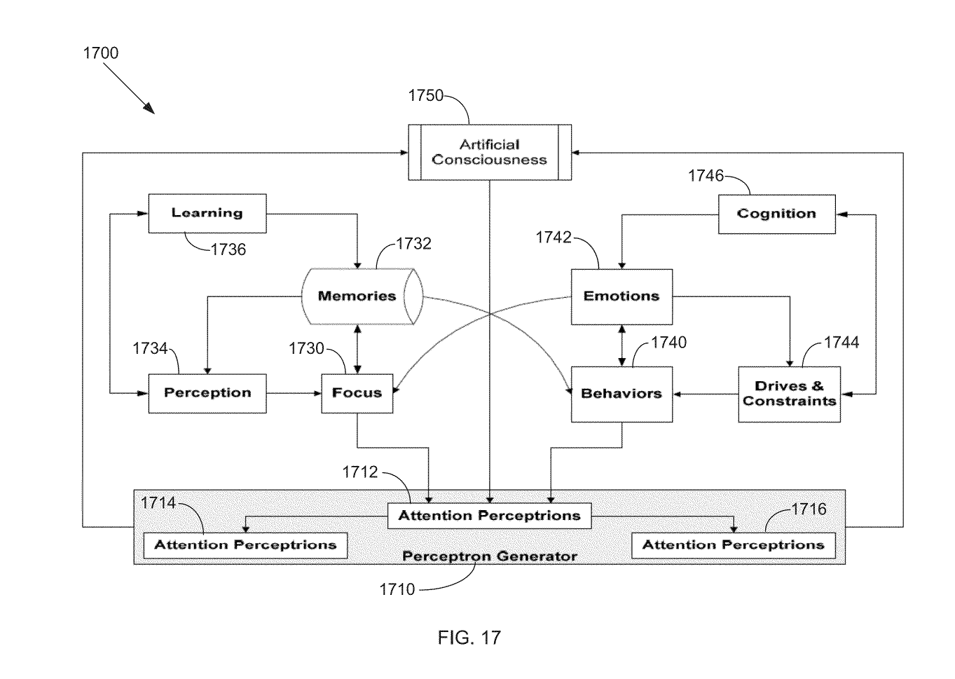

FIG. 17 illustrates a conscious, cognitive agents connectivity architecture 1700 according to an embodiment. The connectivity architecture 1700 shows the connectivity between parts of the overall system. Many of the cognitive processes in the ACNF, e.g., behavior, perception, and cognition, are driven by small, single task cognitive perceptrons. The ACNF structure, as discussed above with reference to FIG. 3, provides a framework for “conscious” software agents, to provide a “plug-in” domain for the domain-independent portions of the “consciousness” mechanism, to provide an easily customizable framework for the domain-specific portions of the “consciousness” mechanism and to provide the cognitive mechanisms for behaviors and emotions for “conscious” software agents.

In FIG. 17, a perceptron generator 1710 is coupled to a focus block 1730 and behaviors block 1740. The perceptron generator 1710 includes a first attention perceptron 1712. A second attention perceptron 1714 and a third attention perceptron 1716 are coupled to the first attention perceptron. Memories 1732 informs behavior block 1740 and emotions 1742 inform focus 1730. Memories 1732 also provide information to perception 1734 and receive information from learning block 1736. Perception 1734 and learning block 1736 communicate to refine the perceptions 1734 and to increase learning by learning block 1736. Perception 1734 provides information to focus 1730. Focus 1730 also communicates with memories 1732 to retrieve and store information.

Emotions 1742 also provide information to drives and constraints 1744 and receive information from cognition block 1746. Drives and constraints 1744 and cognition block 1746 communicate to refine the drives and constraints 1734 and to increase cognition 1746. Drives and constraints 1744 provide information to behaviors 1740. Behaviors 1740 also communicate with emotions 1742 to receive emotions 1742 and to provide information for refining emotions 1742. The perceptron generator 1710 and the artificial consciousness 1750 communicate, wherein the artificial consciousness 1750 provides contextual awareness to the attention perceptrons 1712, 1714, 1716, and the attention perceptrons 1712, 1714, 1716 broadcasts content within the ACNF once it has access to the artificial consciousness 1750.

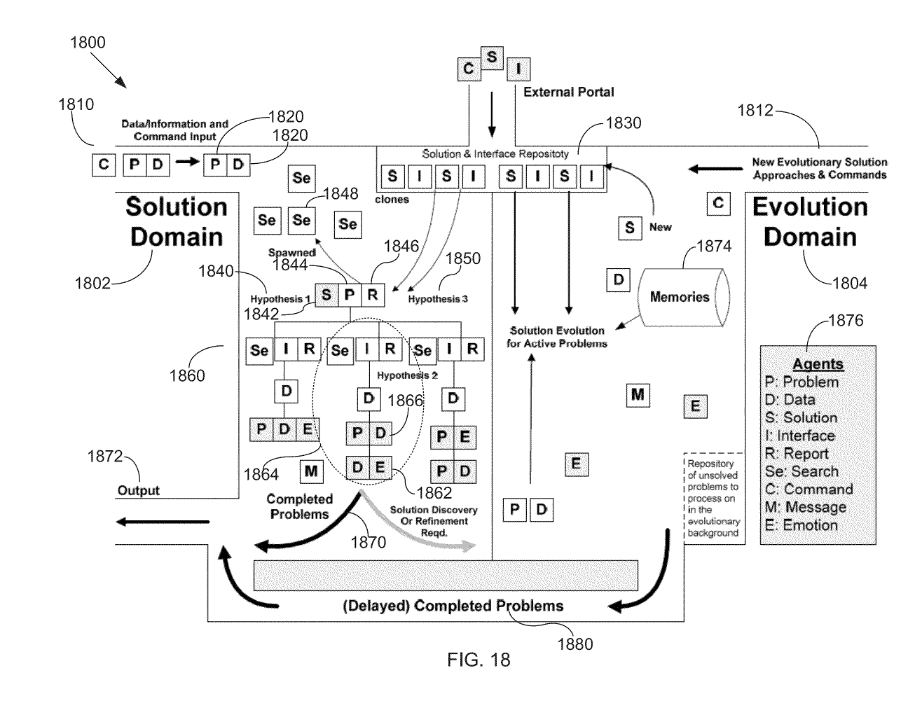

FIG. 18 illustrates ACNF cognitive perceptron artificial cognition infrastructure 1800 that drives the coalitions and provides the infrastructure for the hybrid neural processing environment according to an embodiment. There a number of possible specialized roles within the ACNF for artificial emotions and artificial cognition to produce motivations and goals, and to facilitate learning within the system. Further, there are many types of cognitive perceptrons that are utilized within the ACNF. Cognitive perceptrons provide the ACNF with the ability to mimic human reasoning in processing information and developing knowledge. This intelligence takes the form of answering questions and explaining situations that the ACNF encounters.

Perception involves reception and interpreted of sensory stimuli, e.g., both external and internal inputs, by the perception processes to provide meaning and context for the sensory inputs. At this point, the processing is unconscious processing. There are several perception processes within the artificial cognition subsystem.

For early perception, input 1810 arrive at a solution domain 1802 via the sensors and multiple specialized cognitive perceptrons 1820 attach to the sensory inputs 1810 and extract those features relevant to their specialty. If features are extracted, each cognitive perceptron 1820 will broadcast their observations, analyses, and thought processes onto the artificial cognition processes. New evolutional solution approaches and commands 1812 are also provided at an evolution domain 1804.

Multiple cognitive perceptions 1820 may be activated and utilized for a given set of input 1810 from the sensors. A solution and interface repository 1830 is provided, wherein clones of solutions and interfaces may be provided for use in solving problems. A first hypothesis 1840 may be presented. The ACNF cognitive perceptron artificial cognition infrastructure 1800 analyzes a problem and tries to solve the problem using agents. For example, a solution 1842, a problem 1844 and a report 1846 are provided for a first problem. The report 1846 may spawn a search 1848 for a solution. A third hypothesis 1850 may be provided by the solution and interface repository 1820.

Coalitions of cognitive perceptrons 1860 may be created to facilitate convergence from the different sensory information, along with its context. In this process, relevant emotions 1862 and possible emotional memories are recognized and identified along with the objects and contextual information from the various memory systems within the ACNF. This emotional reaction to external inputs may entail a simple emotional response based on a single cognitive emotional perceptron (CEP) 1862, or it may involve a very complex emotional memory or response that uses another convergence of several CEPs 1862.

The perceptions gained from unconscious processing of external sensory inputs, along with its meaning and context, are stored in working memory, called preconscious buffers. The perceptions are stored in the preconscious buffers before the information is sent on to the artificial cognition subsystem. Depending on the type of sensory information, these buffers could involve the spatio-temporal and spatio-visual, auditory, or other types of information. Emotions and emotional memories may be part of this preconscious perception, depending on what features and triggers are extracted and discovered. These emotions, memories, and contexts are part of the preconscious perceptions stored in the preconscious buffer memories that are transferred to the artificial cognition processes during each cognitive cycle.

Cognitive associations 1864 between a plurality of cognitive perceptrons may be formed: The artificial cognition processes utilize the incoming cognitive perceptrons 1820, along with the preconscious buffer memories and information as cues for creating cognitive hypotheses 1840, 1850 to provide reasoning and inferences about incoming sensory information. This includes emotional 1862 and contextual information 1866.

Completed problems 1870 are provided as output 1872. Problems that need further solution discovery or require refinement may be provided to the evolution domain 1804. Memories 1874 and agents 1876 are used to obtain solution evolution for active problems. Problems completed 1880 in the evolution domain 1804 may then be provided to the output 1872.

The cognitive perceptron solution coalitions, in the end, may create more memories 1874 within the ACNF, including emotional memories, based on the overall response of the system to the current situation. The solution domain 1802 is the front end processor of data and information in which solutions are matched to incoming data 1810. Known solutions 1820, e.g., answers to questions or understanding incoming situational information, may require minor adjustments to parametric values and memories, based on subtle changes to known solutions. The latency parameters in this domain are very short. Thus, unsolved or inadequately solved problems or situations are moved to the evolution domain 1804 for further processing.

Learning within the ACNF denotes changes in the system that enable the ACNF to perform new tasks previously unknown, or to perform tasks already learned more accurately or more efficiently. Learning is constructing or modifying representations of what the ACNF is experiencing. Learning also allows the ACNF to fill in skeletal or incomplete information or specifications about a domain, e.g., self-assessment. The ACNF, or any complex, AI system, cannot be preloaded, or trained autonomous and dynamic updating, i.e., learning, are used to incorporate new information into the system. Learning new characteristics expands the ACNF's domain or expertise and lessens the brittleness of the systems.

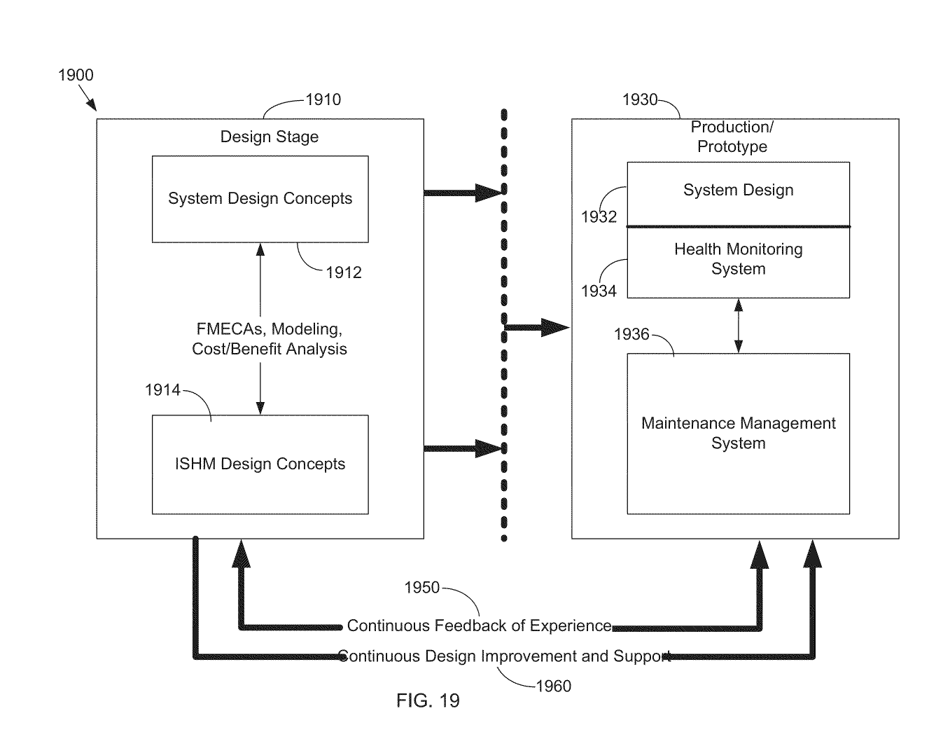

FIG. 19 illustrates a design-in approach to integrated system health management (ISHM) 1900 according to an embodiment. A design stage 1910 includes system design concepts 1912 and ISHM design concepts 1914. Techniques may be applied during the design stage 1910, including failure modes effect and criticality analysis (FMECA), cost/benefit analysis, etc. The production/prototype stage 1930 includes a system design process 1932, a health monitoring system 1934 and a maintenance management system 1936. There is continuous feedback of experience 1950 between the design stage 1910 and the production/prototype 1930. The design stage 1910 provides continuous design improvement and support 1960 to the production/prototype 1930.

Realizing such an approach will involve synergistic deployments of component health monitoring technologies, as well as integrated reasoning capabilities for the interpretation of fault-detect outputs. Further, it will involve the introduction of learning technologies to support the continuous improvement of the knowledge enabling these reasoning capabilities. Finally, it will involve organizing these elements into a maintenance and logistics architecture that governs integration and interoperation within the system, between its on-board elements and their ground-based support functions, and between the health management system and external maintenance and operations functions.

A comprehensive health management system 1936 integrates the results from the monitoring sensors of the health monitoring system 1934 through to the reasoning software that provides decision support for optimal use of maintenance resources. A core component of this strategy is based on the ability to (1) accurately predict the onset of impending faults/failures or remaining useful life of components and (2) quickly and efficiently isolate the root cause of failures once failure effects have been observed. In this sense, if fault/failure predictions may be made, the allocation of replacement parts or refurbishment actions may be scheduled in an optimal fashion to reduce the overall operational and maintenance logistic footprints. From the fault isolation perspective, maximizing system availability and minimizing downtime through more efficient troubleshooting efforts is the primary objective.

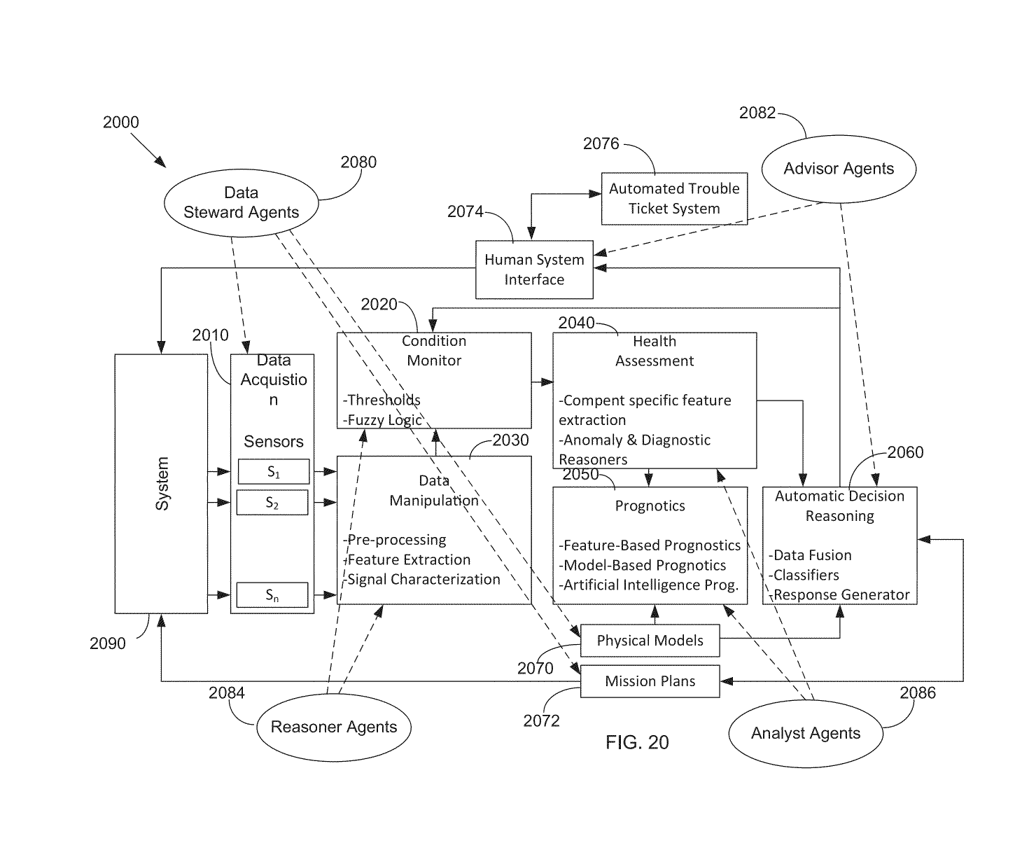

FIG. 20 illustrates functional layers in an integrated system health management (ISHM) system 2000 according to an embodiment. The ISHM system 2000 includes a data acquisition module 2010 that includes sensors 2012, a condition monitor 2020, a data manipulation module 2030, a health assessment module 2040, a prognostics module 2050, and automatic decision module 2060, physical models 2070, mission plans 2072, a human system interface 2074 and an automated trouble ticket system 2076.

Mission plans 2072 are provided to the system 2090 and to the automatic decision reasoning module 2060. The physical models are provided to the prognostics module 2050 and the automatic decision reasoning module 2060. The human system interface 2074 receives data from the automatic decision reasoning module 2060 and provides data to the system 2090 and the data acquisition module 2010. The automatic decision reasoning module 2060 also provides data to the condition monitor.

Sensors 2012 receive data from the system being monitored 2090. The data is provided by the sensors 2012 to the data manipulation module 2030. The data manipulation module 2030 performs pre-processing, feature extraction, and signal characterization. The manipulated data is provided to the condition monitor 2020 by the data manipulation module 2030. The condition monitor 2020 analyzes the manipulated data using fuzzy logic and compares parameters to thresholds. The condition monitor 2020 provides health information to the health assessment module 2040.

The health assessment module 2040 provides component specific feature extraction and anomaly and diagnostic reasoners. The health assessment module 2040 provides input to the automatic decision reasoning module 2060 and to the prognostics module 2050. The prognostics module 2050 includes feature-based prognostics, model-based prognostics, and artificial intelligence prognostics. Developed prognosis is provided to the automatic decision reasoning module 2060. The automatic decision reasoning module 2060 performs data fusion and classification, and generates responses.

The data steward agents 2080 are involved with the data acquisition module 2010, the physical models 2070 and die mission plans 2072. The advisor agents 2082 are involved with the human system interface 2074 and the automatic decision reasoning module 2060. The reasoner agents 2084 are involved with the data manipulation module 2030 and the condition monitor 2020. The analyst agents 2086 are involved with the prognostics module 2050 and the health assessment module 2040.

The prognostic module 2050 assesses and validates prognostics and health management (PHM) system accuracy in the levels of the system hierarchy. Developing and maintaining such an environment will allow for inaccuracies to be quantified at levels in the system hierarchy and then be assessed automatically up through the health management system architecture.

The overall ISHM process includes modeling, sensing, diagnosis, inference and prediction (prognostics), learning, and updating. Two steps in this process include: 1) fault detection and diagnosis and 2) prognostic reasoning (prediction). The final results reported from the reasoner agents 2084 and decision support is a direct result of the individual results reported from these various levels when propagated through. Hence, an approach for assessing the overall PHM system accuracy is to quantify the associated uncertainties at each of the individual levels, and build up the accumulated inaccuracies as information is passed up the system architecture.

This type of hierarchical verification and validation (V&V) and maturation process will be able to provide the capability to assess the automatic decision reasoning module 2060 and the prognostics module 2050 in terms of their ability to detect subsystem faults, diagnose the root cause of the faults, predict the remaining useful life of the faulty component, and assess the decision-support reasoner algorithms. Specific metrics include accuracy, false-alarm rates, reliability, sensitivity, stability, economic cost/benefit, and robustness, just to name a few.

Cost-effective implementation of the automatic decision reasoning module 2060 and the prognostics module 2050 will vary depending on the design maturity and operational logistics environment of the monitored equipment.

However, one common element to successful implementation is feedback. As components or LRUs are removed from service, disassembly inspections may be performed to assess the accuracy of the decisions by the automatic decision reasoning module 2060 and the prognostics module 2050. Based on this feedback, system software and warning/alarm limits may be optimized until predetermined system accuracy and warning intervals are achieved. In addition, selected examples of degraded component parts may be retained for testing that may better define failure progression intervals.

A systems-oriented approach to prognostics augments the failure detection and inspection-based methods with forecasting of parts degradation, mission criticality and decision support. The prognostics module 2050 deals not only with the condition of individual components, but also the impact of this condition on the mission-readiness and the ability to take appropriate actions. However, such a continuous health management system may be carefully engineered at the stages of a system design, operation and maintenance.

The condition monitor 2020 and the health assessment module 2040 determine if a component/subsystem/system has moved away (degraded) from nominal operating parameters, along a known path, to a point where component performance may be compromised. Novelty detection determines if the component has moved away from what is considered acceptable nominal operations and away from known fault health propagation paths.

The prognostics module 2050 assesses a component's current health and a prediction of the component's future health, or Useful Remaining Life (URL). There are two variations of the prediction problem. The first prediction type may have just a short horizon time—is the component good to fly the next mission? The second type is to predict how much time before a particular fault will occur and, by extension, how much time before the component is to be replaced. If interest in a longer term, an indication of when to schedule removal of an engine for overhaul may be provided. ISHM 2000 relies on accurate prognosis. The creation of a prognostic algorithm is a challenging problem. There are several areas that may be addressed in order to develop a prognostic reasoner that achieves a given level of performance. The intelligent Human System Interface (HSI) 2074 provides the user with relevant, context-sensitive information about system condition. An ISHM 2500 may thus provide a complete range of functionality from data collection through recommendations for specific actions.

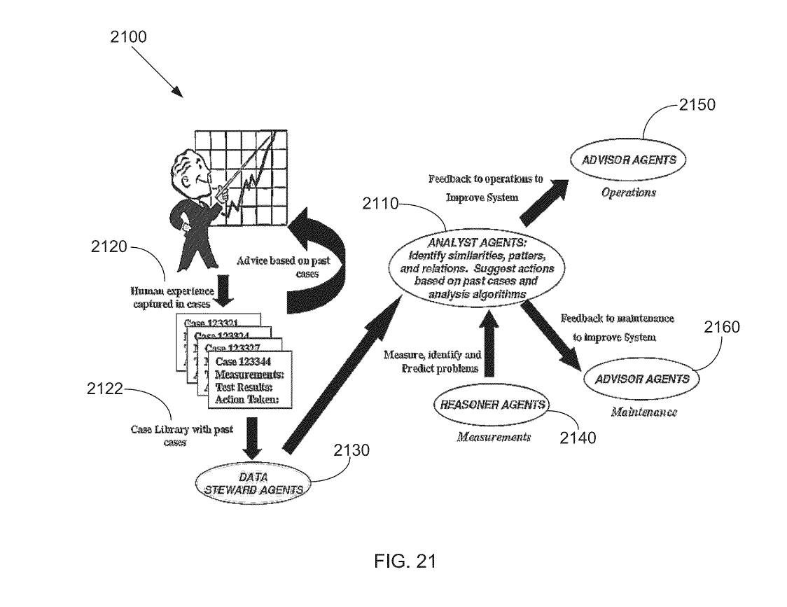

FIG. 21 illustrates intelligent information agents (I²A) for a prognostic process 2100 according to an embodiment. The prognostics component 2100 uses analyst agents 2110 and provides specific information to the advisor agents 2110 about the system's state of health, status, RUL, confidence and recommendations. Human experience is captured in cases 2120. A case library with past cases 2122 is provided to data steward agents 2130. The data steward agents 2130 provide the data to the analyst agent 2110. Reasoner agents 2140 measure, identify and predict problems. The analyst agents 2110 identify similarities, patterns and relations. The analyst agents 2110 also suggest actions based on past cases and analysis algorithms. The analyst agents 2110 provide feedback to operations managed by advisor agents 2150 to improve the system. The analyst agents 2110 also provide feedback to maintenance, which is provided by advisor agents 2160.

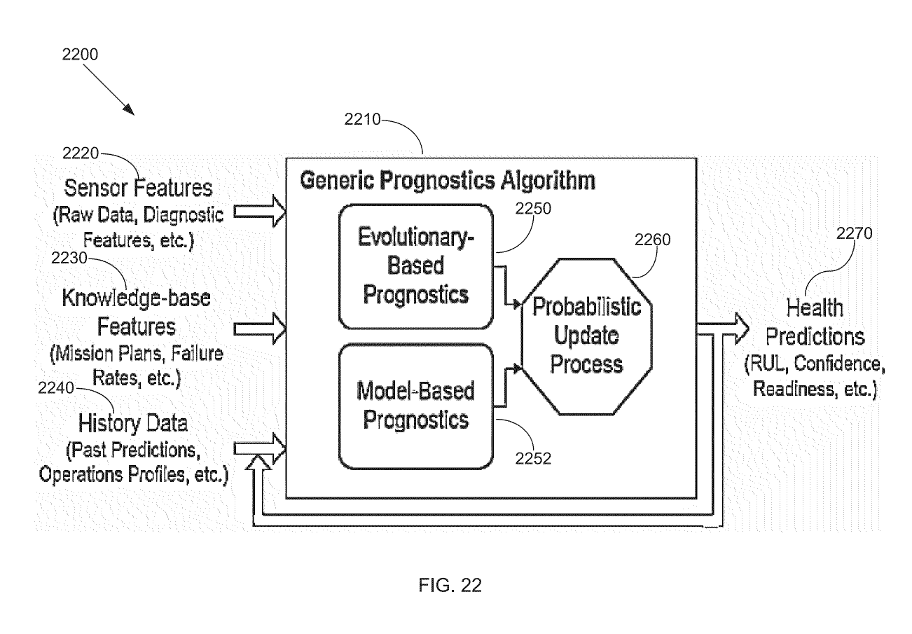

FIG. 22 illustrates prognostic analyst agent processing 2200 according to an embodiment. In FIG. 22, the prognostics algorithm 2210 receives sensor features 2220, such as raw data, diagnostic features, etc., knowledge-based features 2230, such as mission plans, failure rates, etc., and history data 2240, such as past predictions, operations profiles, etc. An evolutionary-based prognostics 2250 and module-based prognostics 2252 process the incoming data 2220, 2230, 2240 and provide input to a probabilistic update process 2260. The prognostics algorithm 2210 produces health predictions 2270, such as RUL, confidence, readiness, etc., at an output and as feedback to the history data 2240,

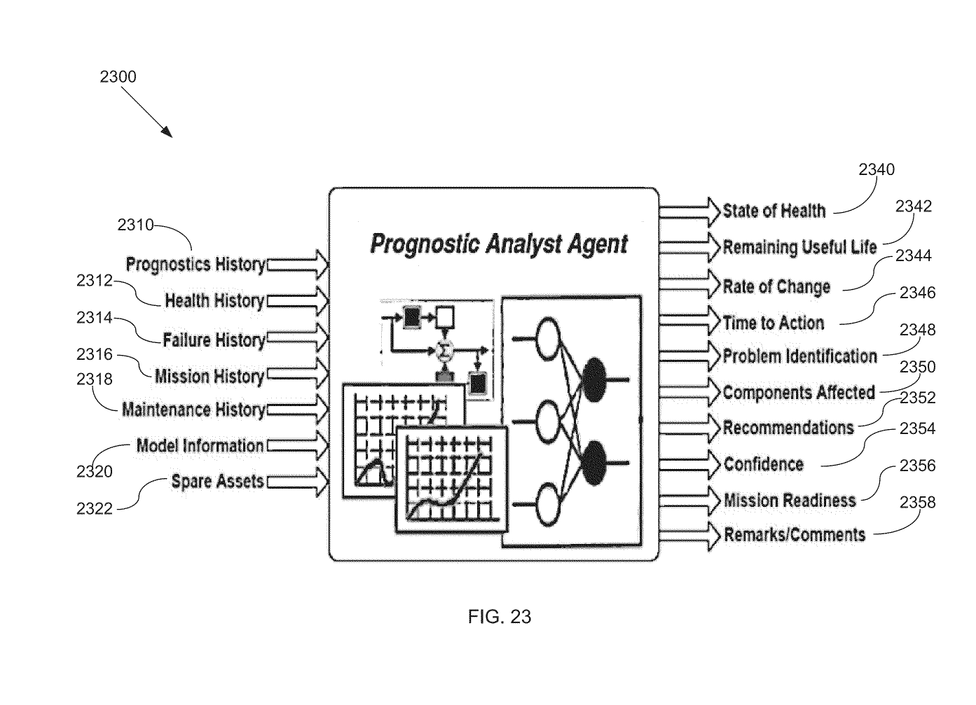

FIG. 23 shows the inputs and outputs to a prognostics analyst agent 2300 according to an embodiment. The prognostics analyst agent 2300 receives prognostics history 2310, health history 2312, failure history 2314, mission history 2316, maintenance history 2318, model information 2320 and spare assets data 2322. The prognostics analyst agent 2300 produces information regarding the state of health of the system 2340, the remaining useful life 2342, the rate of change of a system from a norm 2344, a time to action 2346, an identification of the problem 2348, the components affected 2350, recommendations 2352, a confidence level 2354, a mission readiness 2356 and remarks/comments 2358,

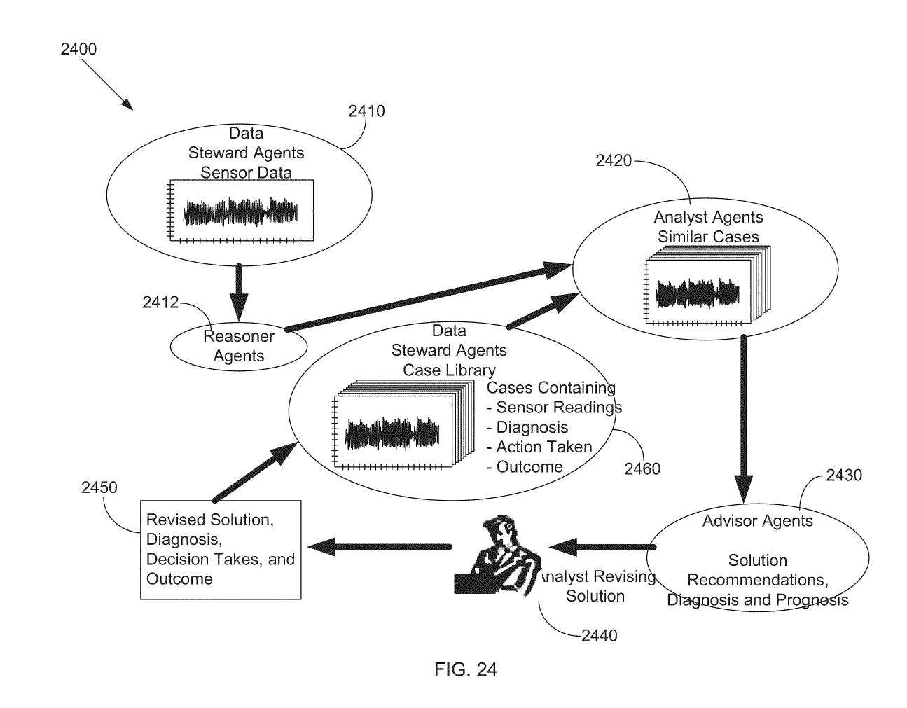

FIG. 24 illustrates the ISHM decision making process 2400 according to an embodiment. Data steward agents 2410 obtain sensor data and pass it to reasoner agents 2412. The reasoner agents 2412 pass the data to analyst agents 2420. The analyst agents 2420 identify similar cases and provide the data to advisor agents 2430. The advisor agents 2430 identify solution recommendations, diagnosis, and prognosis. The advisor agents 2430 provide this data to analyst 2440 to review and revise the solution. The analyst 2440 provides the revised data to a database 2450, wherein the revised solution, diagnosis, decision taken and the outcome are stored. Data steward agents 2460 obtain the data from the database 2450 and include it in a case library. The case library may be provided to the analyst agents 2420.

The advisor agents 2430 provide recommended actions and alternatives and the implications of each recommended action. Recommendations may include maintenance action schedules, modifying the operational configuration of assets and equipment in order to accomplish mission objectives, or modifying mission profiles to allow mission completion. The advisor agents 2430 take into account operational history, including usage and maintenance, current and future mission profiles, high-level unit objectives, and resource constraints. There is a human-in-the-loop analyst 2440 to assess the correctness of major decisions and adjust the decision process.

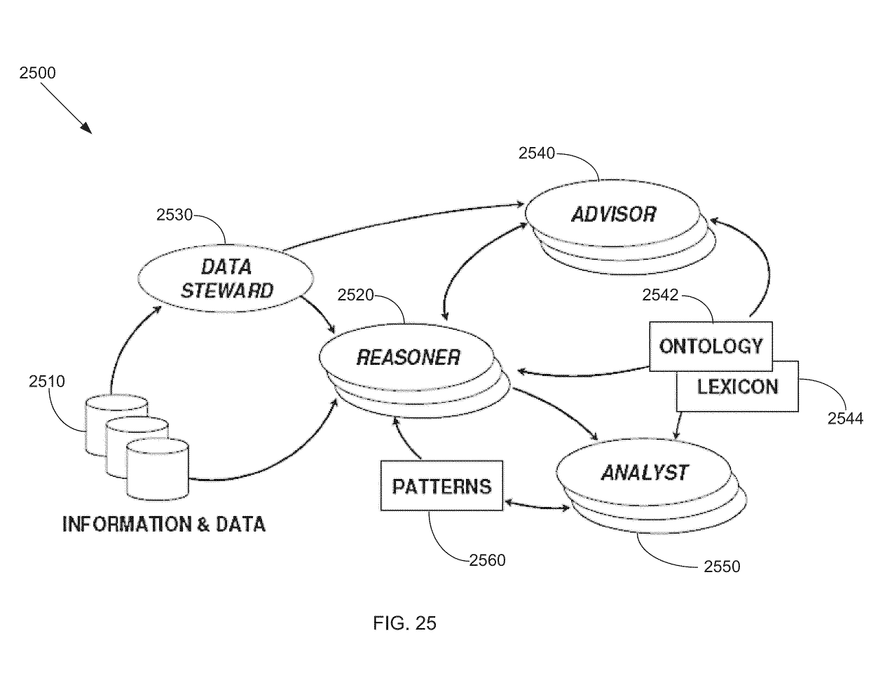

FIG. 25 illustrates intelligent information agents (I²A) network system 2500 according to an embodiment. The functions that an I²A network system 2500 facilitate include sensing and data acquisition (data steward agents 2530), signal processing and feature extraction (reasoner agents 2520), production of alarms or alerts (advisor agents 2540), failure or fault diagnosis and health assessment (analyst agents 2550), prognostics: projection of health profiles to future health or estimation of remaining useful life (RUL) involving analyst agents 2550 and advisor agents 2540, decision reasoning: recommendations or evaluation of asset readiness for a particular operational scenario (advisor agents 2540), management and control of data flows and/or test sequences (data steward agents 2530, management of historical data storage and historical data access (data steward agents 2530), system configuration management (data steward agents 2530), human system interface (interface agents/advisor agents 2540).

An I²A is an autonomous agent situated in and part of the information ecosystem, comprehending its environment and acting upon over time, in pursuit of its own agenda, so as to effect what it comprehends in the future. The I²As have certain abilities that distinguish it from software objects and programs and provide it with the intelligence it needs to mimic human reasoning.

In FIG. 25, information and data 2510 are provided to a reasoner agent 2520 and to a data steward agent 2530. The data steward agent 2530 provides input to an advisor agent 2540 and to the reasoner agent 2520. An ontology 2542 and a lexicon 2544 provide input to the advisor agent 2540, the reasoner agent 2520 and an analyst agent 2550. Patterns 2560 are provided to the analyst agent 2550 and the reasoner agent 2520, and the analyst agent 2550 provides pattern input to the patterns 2560. The reasoner agent 2520 in turn provides data to the analyst agent 2550. The advisor agent 2540 and the reasoner agent 2520 communicate to share data.

I²As may be used to build multi-agent intelligent autonomic systems. This includes the framework for providing business rules and policies for run-time systems, including an autonomic computing core technology within a multi-agent infrastructure. The I²A network system 2500 uses experts and information to answer questions. The I²A network system 2500 performs answer extraction to find information that is a solution to a problem and performs situation analysis to discover situations that require active investigation.

The I²A network system 2500 uses genetic, neural-network and fuzzy logic that are used to integrate diverse sources of information, associate events in the data and make observations. When combined with a dialectic search, the application of hybrid computing promises to revolutionize information processing. The dialectic search seeks answers to questions that require interplay between doubt and belief, where knowledge is understood to be fallible. This playfulness is involved in hunting information and is explained in more detail below regarding the description of the dialectic argument structure. The dialectic search avoids the problems associated with analytic methods and word searches. In its place, information is used to develop and assess hypotheses seeded by a domain expert. This is achieved using I²As that augments human reason by learning from the expert how to argue and develop a hypothesis.

The use of intelligent information agents 2520, 2530, 2540, 2550 allows both granular approaches, e.g., individual agents implementing individual functions, and integrated approaches, e.g., individual agents collaborating together to integrate a number of functions. The I²A network system 2500 takes into account data flow parameters to control flexibility and performance across the I²A network system 2500. This allows the I²A network system 2500 to support the full range of data flow parameters through both real-time and event-based data reporting and processing. Time-based reporting is further categorized as periodic or aperiodic. The event-based reporting and processing is based upon the occurrence of events (e.g., exceeding limits, state changes, etc.),

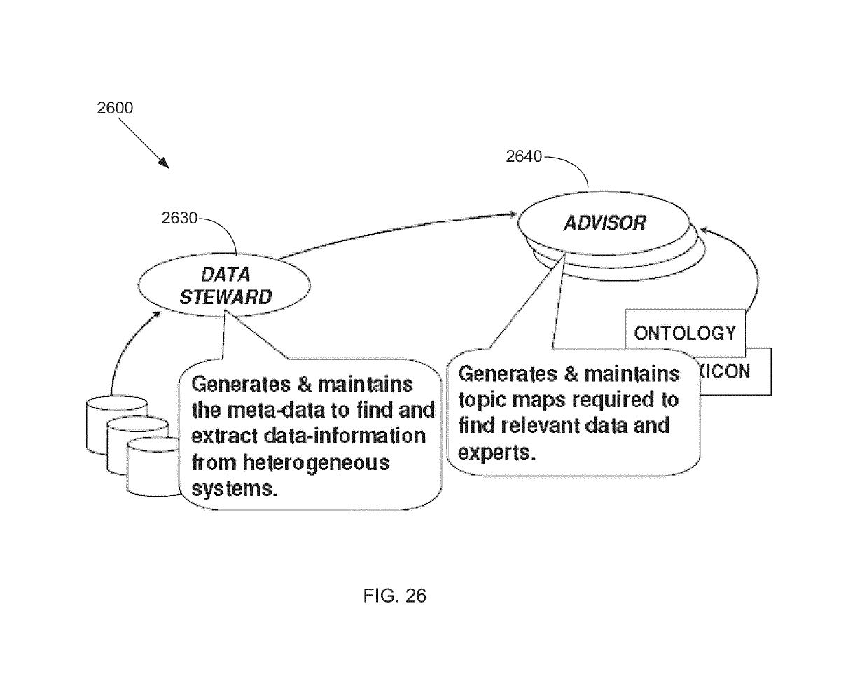

FIG. 26 illustrates a functions 2600 data steward and advisor agent according to an embodiment. In FIG. 26, a data steward agent 2630 communicates with an advisor agent 2640. The data steward agent 2630 generates and maintains metadata to find and extract data and information from heterogeneous systems. The advisor agent 2640 generates and maintains topic maps that are used to discover relevant data and experts.

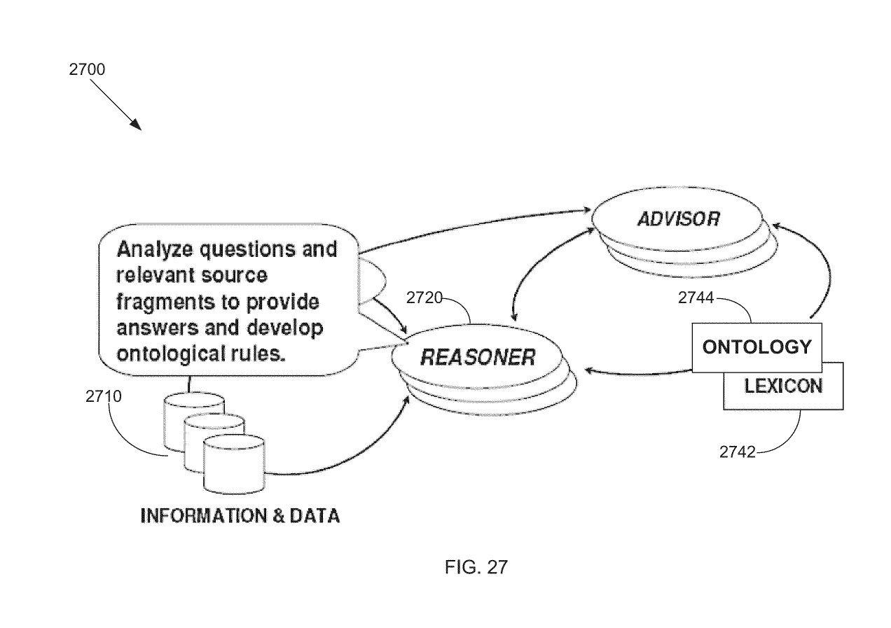

FIG. 27 illustrates functions 2700 of a reasoner agent according to an embodiment. In FIG. 27, reasoner agent 2720 analyzes questions and relevant source fragments to provide answers and develop ontological rules. The reasoner agent 2720 bases the analysis on information and data 2710 received from a database and ontology data 2742 and lexicon data 2744.

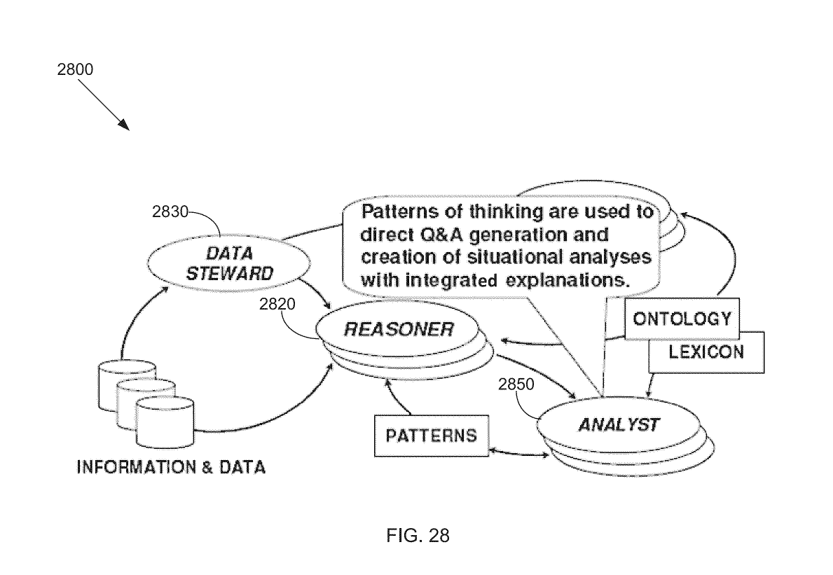

FIG. 28 illustrates functions 2800 of an analyst agent according to an embodiment. In FIG. 28, an analyst agent 2850 uses patterns of thinking to direct question and answer generation and to create situational analysis with integrated explanations. Expanded questions and answers are used by the analyst agent 2850 to learn from collected information. The analyst agent 2850 also evolves pattern languages that best explain the situational being analyzed. Knowledge is interactively shared between agents, such as data steward agent 2830, reasoner agent 2820 and analyst agent 2850, as well as end-users.

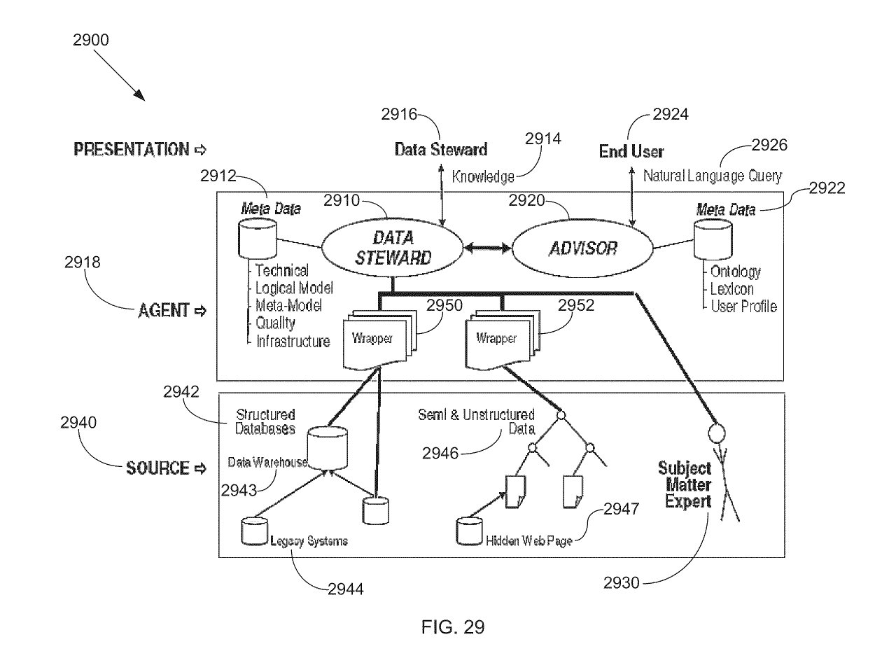

FIG. 29 illustrates a federated search process within the integrated system health management system 2900 according to an embodiment. The federated search process 2900 includes search information agents, e.g., data steward agent 2910 and advisor agent 2920, that mine through multiple sources to provide data/information to other intelligent information agents throughout the ISHM processing environment. Data steward agent 2910 and advisor agent 2920 have access to metadata database 1 2912 and metadata 2 2922, respectively. Knowledge 2914 may be passed between data steward agent 2910 and other data steward agents 2916. An end user 2924 may make a natural language query 2926 to advisor agent 2920. Source data 2940 may be provided to the agents 2918. For example, wrappers 2950 may have access to structured databases 2942 including data warehouse 2943 and legacy systems 2944. Wrappers 2952 may have access to semi- and un-structured data 2946 including hidden web page 2947.

The federated search process 2900 includes utilizing subject matter experts (SMEs) 2930 to provide initial information to ISHM. The system cannot just spontaneously generate initial knowledge, it may be fed information to learn from, i.e., not just train as in traditional neural network systems, but learn the information. This includes a learning based question and answer processing architecture that allows the ISHM processing environment to ask questions,

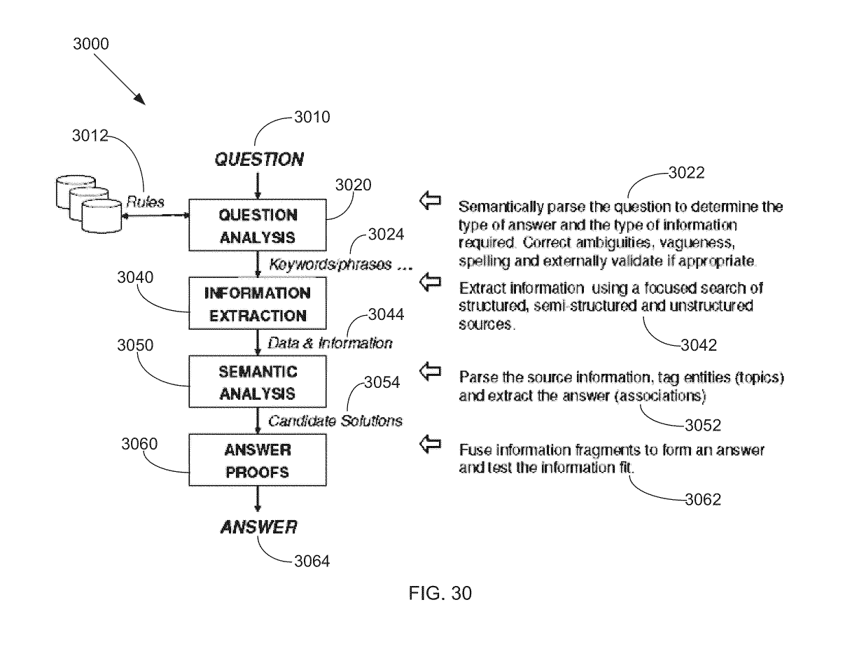

FIG. 30 illustrates a question and answer architecture 3000 for the integrated system health management system according to an embodiment. The question and answer architecture 3000 is a learning based question and answer processing architecture that allows the ISHM processing environment to ask questions, based on contextual understanding of the information it is processing, and extract answers, either from its own inference engines, its own memories, other information contained in its storage systems, or outside information from other information sources, or SMEs.

In FIG. 30, questions 3010 are provided to a question analysis agent 3020. Rules 3012 are provided to the question analysis agent 3020. The question is semantically parsed to determine the type of answer and the type of information used, and ambiguities, vagueness, and spelling are corrected and externally validated if appropriate 3022. Keyword and phrases 3024 are provided to information extraction 3040. Information is extracted using a focused search of structured, semi-structured and unstructured sources 3042. Data and information 3044 are provided to semantic analysis 3050. The source information and tag entities are (topics) parsed and the answer (associations) are extracted 3052. Candidate solutions 3054 are provided to answer proofs 3060. Information fragments are fused to form an answer, and the information fit is tested 3062. The answer proofs 3060 provide an answer 3064.

Referring again to FIG. 16, the functional layers 1620, 1630, 1640 in an integrated system health management system allows the modern ISHM architecture to comprise a host of functional capabilities, including sensing and data acquisition, signal processing, conditioning and health assessment, diagnostics and prognostics, decision reasoning, etc.

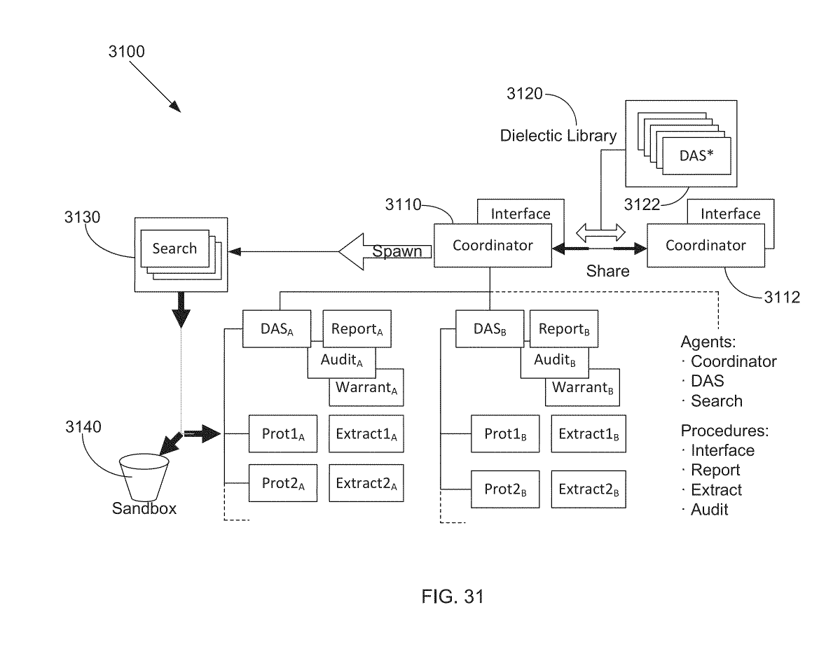

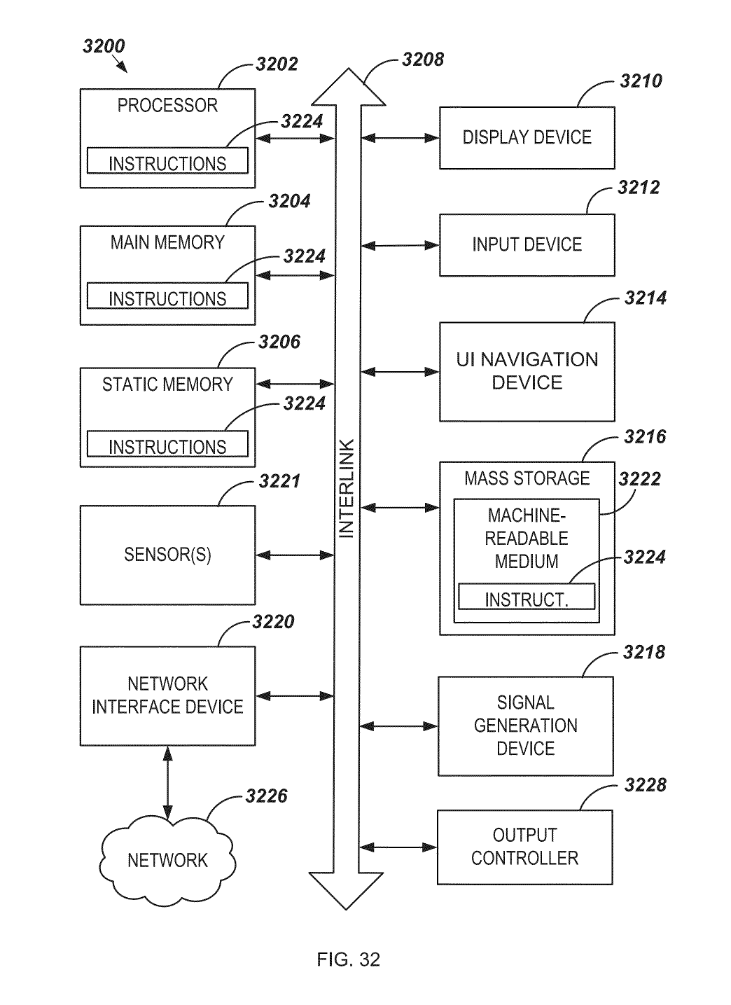

FIG. 31 illustrates a possible intelligent dialectic search argument (DSA) software agency 3100 according to an embodiment. The intelligent dialectic search argument (DSA) software agency 3100 uses three different agents. In FIG. 32, a coordinator 3110 shares data with other coordinators 3112. Dialectic library 3120 provides dialectic search arguments 3122 to the coordinators 3110, 3112. The coordinators 3110, 3112 responds to new hits (input) that conforms to patterns of known interest. When an interesting hit occurs, the coordinators 3110, 3112 select one or more candidate DAS agents 3122 and spawns a search agent 3130 to find information relevant to each DAS 3122. The search agent 3130 provides information to a sandbox 3140. Thus, coordinators 3110, 3112, the DAS 3122 and the search agents 3130 work together, each having its own learning objectives.

The inter-agent communication between the coordinators 3110, 3112, the DAS 3122 and the search agents 3130 allows shared awareness, which in turn, enables faster operations and more effective information analysis and transfer, providing users with an enhanced visualization of overall constellation and situational awareness across an ISHM infrastructure. The intelligent agent-based ISHM may deal with massive amounts of information to levels of accuracy, timeliness, and quality heretofore impossible. Data steward agents, as discussed above, will support growing volumes of data and allow applications that deal with object-oriented technologies to achieve the goats of awareness, flexibility, and agility. The flexible, learning, adapting I²As of an ISHM system may adapt, collaborate, and provide the increased flexibility for a growing, changing environment.

FIG. 32 illustrates a block diagram of an example machine 3200 for providing artificial continuously recombinant neural fiber network according to an embodiment upon which any one or more of the techniques (e.g., methodologies) discussed herein may perform. In alternative embodiments, the machine 3200 may operate as a standalone device or may be connected (e.g., networked) to other machines. In a networked deployment, the machine 3200 may operate in the capacity of a server machine and/or a client machine in server-client network environments. In an example, the machine 3200 may act as a peer machine in peer-to-peer (P2P) (or other distributed) network environment. The machine 3200 may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, white a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, at least a part of one or more computer systems (e.g., a standalone, client or server computer system) or one or more hardware processors 3202 may be configured by firmware or software (e.g., instructions, an application portion, or an application) as a module that operates to perform specified operations. In an example, the software may reside on at least one machine readable medium. In an example, the software, when executed b the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform at least part of any operation described herein. Considering examples in which modules are temporarily configured, a module need not be instantiated at any one moment in time. For example, where the modules comprise a general-purpose hardware processor 3202 configured using software; the general-purpose hardware processor may be configured as respective different modules at different times. Software may accordingly configure a hardware processor, for example, to constitute a particular module at one instance of time and to constitute a different module at a different instance of time. The term “application or variants thereof, is used expansively herein to include routines, program modules, programs, components, and the like, and may be implemented on various system configurations, including single-processor or multiprocessor systems, microprocessor-based electronics, single-core or multi-core systems, combinations thereof, and the like. Thus, the term application may be used to refer to an embodiment of software or to hardware arranged to perform at least part of any operation described herein.

Machine (e.g., computer system) 3200 may include a hardware processor 3202 (e.g., a central processing unit (CPU), a graphics processing unit (GPU), a hardware processor core, or any combination thereof), a main memory 3204 and a static memory 3206, at least some of which may communicate with others via an interlink (e.g., bus) 3208. The machine 3200 may further include a display unit 3210, an alphanumeric input device 3212 (e.g., a keyboard), and a user interface (111) navigation device 3214 (e.g., a mouse). In an example, the display unit 3210, input device 3212 and UI navigation device 3214 may be a touch screen display. The machine 3200 may additionally include a storage device (e.g., drive unit) 3216, a signal generation device 3218 (e.g., a speaker), a network interface device 3220, and one or more sensors 3221, such as a global positioning system (GPS) sensor, compass, accelerometer, or other sensor. The machine 3200 may include an output controller 3228, such as a serial (e.g., universal serial bus (USB), parallel, or other wired or wireless (e.g., infrared (IR)) connection to communicate or control one or more peripheral devices (e.g., a printer, card reader, etc.).

The storage device 3216 may include at least one machine readable medium 3222 on which is stored one or more sets of data structures or instructions 3224 (e.g., software) embodying or utilized by any one or more of the techniques or functions described herein. The instructions 3224 may also reside, at least partially, additional machine readable memories such as main memory 3204, static memory 3206, or within the hardware processor 3202 during execution thereof by the machine 3200. In an example, one or any combination of the hardware processor 3202, the main memory 3204, the static memory 3206, or the storage device 3216 may constitute machine readable media.

While the machine readable medium 3222 is illustrated as a single medium, the term “machine readable medium” may include a single medium or multiple media (e.g., a centralized or distributed database, and/or associated caches and servers) that configured to store the one or more instructions 3224.

The term “machine readable medium” may include any medium that is capable of storing, encoding, or carrying instructions for execution by the machine 3200 and that cause the machine 3200 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having resting mass. Specific examples of massed machine readable media may include: non-volatile memory, such as semiconductor memory devices (e.g., Electrically Programmable Read-On) Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 3224 may further be transmitted or received over a communications network 3226 using a transmission medium via the network interface device 3220 utilizing any one of a number of transfer protocols (e.g., frame relay, internet protocol UP), transmission control protocol (TCP), user datagram protocol DP), hypertext transfer protocol (HTTP), etc.). Example communication networks may include a local area network (LAN), a wide area network (WAN), a packet data network (e.g., the Internet), mobile telephone networks ((e.g., channel access methods including Code Division Multiple Access (CDMA), Time-division multiple access (TDMA), Frequency-division multiple access (FDMA), and Orthogonal Frequency Division Multiple Access (OFDMA) and cellular networks such as Global System for Mobile Communications (GSM), Universal Mobile Telecommunications System (UNITS), CDMA 2000 1x* standards and Long Term Evolution (LTE)), Plain Old Telephone (POTS) networks, and wireless data networks (e.g., Institute of Electrical and Electronics Engineers (IEEE) 802 family of standards including IEEE 802.11 standards (WiFi), IEEE 802.16 standards (WiMax®) and others), peer-to-peer (P2P) networks, or other protocols now known or later developed.

For example, the network interface device 3220 may include one or more physical jacks (e.g., Ethernet, coaxial, or phone jacks) or one or more antennas to connect to the communications network 3226. In an example, the network interface device 3220 may include a plurality of antennas to wirelessly communicate. The term “transmission medium” shall be taken to include any intangible medium that is capable of storing, encoding or carrying instructions for execution by the machine 3200, and includes digital or analog communications signals or other intangible medium to facilitate communication of such software.

The above detailed description includes references to the accompanying drawings, which form apart of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the ter “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein,” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc, are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth features disclosed herein because embodiments may include a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. An artificial intelligence system, comprising:
an artificial cognitive neural framework arranged to organize information semantically into meaningful fuzzy concepts and information fragments that create cognitive hypotheses as part of its topology;
an artificial continuously recombinant neural fiber network, including a plurality of neurons and interconnections, arranged to determine constraint optimization for optimizing continuous adjustments in inter-neural perception between the plurality of neurons;
an artificial prefrontal cortex arranged to provide a structure and context for artificial feelings and emotions for action selection and learning events
an evolving, yielding, symbiotic environment (ELYSE) cognitive system arranged to dynamically adapt structure based on acquired knowledge about types of environments encountered; and
an integrated system health management system (ISHM) arranged to turn data into meaningful information, to reason about the information in a relative context and to update the information in real-time.

2. The artificial intelligence system of claim 1, wherein the integrated system health management system is arranged to provide an intelligent information agent processing environment for processing the data into relevant, actionable knowledge.

3. The artificial intelligence system of claim 1, wherein the artificial cognitive neural framework comprises a collection of constraints, building blocks, design elements, and rules for composing cognitive aspects including a cognitive system, a mediator and a memory system.

4. An artificial cognitive neural framework, comprising:
a memory system for storing acquired knowledge and for broadcasting the acquired knowledge;
cognitive system, including cognitive perceptrons arranged to develop hypotheses and produce information, and genetic learning algorithms; and
a mediator, coupled to the cognitive system, the mediator arranged to gather the developed hypotheses and the produced information, to integrate the developed hypotheses and produced information using fuzzy, self-organizing contextual topic maps and to establish proper mappings between inputs, internal states and outputs of a continuously recombinant neural fiber network;
wherein the genetic learning algorithms are arranged to continuously evolve candidate solutions by adjusting interconnections in the continuously recombinant neural fiber network by correlating patterns within the candidate solutions to stochasto-chaotic constraints, and to update the memory system.

5. The artificial cognitive neural framework of claim 4, wherein the memory system includes short term memory, long term memory and episodic memory.

6. The artificial cognitive neural framework of claim 4, wherein the memory system further includes perceptual memory, working memory, autobiographical memory, procedural memory and emotional memory.

7. The artificial cognitive neural framework of claim 4, wherein the produced information includes information and questions associated with internal processes and questions associated with external operators.

8. The artificial cognitive neural framework of claim 4, wherein the cognitive system is further arranged to receive external information and emotional context information used for developing the hypotheses and producing the information.

9. The artificial cognitive neural framework of claim 4, wherein the fuzzy, self-organizing topical map, genetic learning algorithms, and stochasto-chaotic constraints are applied to the interconnections within the continuously recombinant neural fiber network to determine constraint optimization for capturing characteristics of a knowledge object.

10. The artificial cognitive neural framework of claim 4, wherein the genetic learning algorithms include dialectic search structures.

11. The artificial cognitive neural framework of claim 4, wherein the genetic learning algorithms include Occam learning algorithms arranged to formulate new hypotheses about data, information, and situations not previously encountered.

12. The artificial cognitive neural framework of claim 4, wherein the genetic learning algorithms include evolutionary programming algorithms arranged to divide a population of inputs into different species based on a compatibility distance measure utilizing the fuzzy, self-organizing topical maps.

13. The artificial cognitive neural framework of claim 4, wherein the fuzzy, self-organizing contextual topical map comprises a first fuzzy, self-organizing topical map arranged to organize information semantically into topics based on derived topical eigenspaces of features within information and the fuzzy, self-organizing contextual topical map, wherein the derived topical eigenspaces are mapped to fuzzy, self-organizing contextual topical map to show cognitive influences and ties to larger cognitive processes and memory information.

14. The artificial cognitive neural framework of claim 4, wherein the genetic learning algorithms learn possibilistic correlations present in a data environment to generalize behavior to a new environment.

15. A method for providing an artificial cognitive neural framework, comprising:
storing acquired knowledge in a memory system;
broadcasting the acquired knowledge in the memory system;
developing hypotheses and producing information using a cognitive perceptrons in a cognitive system;
gathering the developed hypotheses and the produced information at a mediator for integrating the developed hypotheses and produced information using fuzzy, self-organizing contextual topic maps;
establishing proper mappings between inputs, internal states and outputs of a continuously recombinant neural fiber network based on the integration of the developed hypotheses and produced information;
continuously evolving candidate solutions using a genetic learning algorithm by adjusting interconnections in the continuously recombinant neural fiber network by correlating patterns within the candidate solutions to stochasto-chaotic constraints; and
updating the memory system based on the correlation of patterns within the candidate solutions to create the acquired knowledge.

16. The method of claim 15 further comprising receiving, at the cognitive system, external information and emotional context information used for developing the hypotheses and producing the information.

17. The method of claim 15, wherein the continuously evolving candidate solutions using a genetic learning algorithm further comprises arranging Occam learning algorithms to formulate new hypotheses about data, information, and situations not previously encountered.

18. The method of claim 15 further comprising dividing a population of inputs into different species using evolutionary programming algorithms based on a compatibility distance measure utilizing, the fuzzy, self-organizing topical maps.

19. The method of claim 15 further comprising organizing information semantically into topics, using the first fuzzy, self-organizing topical map, based on derived topical eigenspaces of features within information and mapping the derived topical eigenspaces to a fuzzy, self-organizing contextual topical map to show cognitive influences and ties to larger cognitive processes and memory information.

20. The method of claim 15 further comprising learning possibilistic correlations present in a data environment, using the genetic learning algorithms, to generalize behavior to a new environment.
